(19) United States
(12) Patent Application Publication
(10) Pub. No.: US 2018/0301923 A1
(43) Pub. Date: Oct. 18, 2018

(54) METHODS AND SYSTEM FOR CONTROLLING A WIRELESS POWER TRANSMITTER

(71) Applicant: QUALCOMM Incorporated, San Diego, CA (US)

(72) Inventors: Mark White, II, San Diego, CA (US); Cody Wheeland, San Diego, CA (US); Seong Heon Jeong, San Diego, CA (US); William Henry Von Novak, III, San Diego, CA (US)

(21) Appl. No.: 15/489,667

(22) Filed: Apr. 17, 2017

(51) Int. Cl. H02J 7/02; H02J 50/12; H02J 50/40; H02J 50/80; H02J 50/90

(52) U.S. Cl. CPC H02J 7/025; H02J 50/12; H02J 50/90; H02J 50/80; H02J 50/40

(57) ABSTRACT

An aspect of this disclosure is an apparatus for transmitting power wirelessly. The apparatus comprises a detection circuit and a processor. The apparatus also includes a power amplifier driving an antenna circuit of flexible antenna(s) configured for wireless power transfer. The processor determines that at least one measured variable of the power amplifier falls outside of a corresponding threshold range, indicative of a deformation of a physical shape of one of the flexible antennas or indicative of misalignment of the flexible antennas from a power receiver. The processor further commands the power amplifier to transition to a first power mode from a second power mode based on the determination that at least one of the measured variables falls outside of the corresponding threshold range. The antenna circuit in the first power mode transmits power at a power level less than the power level in the second power mode.

### BACKGROUND

### Field

The present disclosure relates generally to wireless power transfer, and more specifically to methods and apparatus for wirelessly conveying power to electronic devices that may be implanted within or worn on a user body.

### Description of the Related Art

Electronic devices capable of attaching to nerves or being implanted within particular organs or regions of a body are becoming more popular. The devices (e.g., implants) allow for both monitoring and stimulation of nerves or the organs to which the implants are connected. Accordingly, the implants allow for diagnosis and treatment of various diseases and conditions. Additionally, several other types of medical implants, for example insulin level monitors, insulin pumps, pacemakers, which may be more “critical” to maintaining conditions and regulating operation of the body, are becoming more widely used. Medical implants that provide for monitoring and control often require power to operate. While this power may be provided by a primary battery, primary batteries integrated into the implants may be problematic. For example, the primary batteries may require periodic replacement, and thus require regular surgeries to access the implants. It is safer and less invasive to charge the implants wirelessly.

In some implementations, implants may be wirelessly charged as part of a wireless power charging system. In wireless power applications, wireless power charging systems may provide the ability to charge and/or power electronic devices without physical, electrical connections, thus reducing the number of components required for operation of the electronic devices and simplifying the use of the electronic device. Such wireless power charging systems may comprise a wireless power transmitter and other transmitting circuitry located outside of the user's body and configured to generate a wireless charging field that may be used to wirelessly transfer power to wireless power receivers implanted within or positioned on the user's body. However, when a transmitting antenna of the wireless power transmitter is flexible and is worn by the user, a shape of the antenna may change as the user is wearing it. For example, the antenna may have a first, substantially linear shape while the user is standing but may contort into a folded or curved shape when the user is seated. Accordingly, there is a need for methods and apparatus for detecting a shape and/or condition of the transmit antenna using parameters of the wireless charging field and control charging capabilities of the transmitter accordingly.

### SUMMARY

Various implementations of methods and devices within the scope of the appended claims each have several aspects, no single one of which is solely responsible for the desirable attributes described herein. Without limiting the scope of the appended claims, some prominent features are described herein.

An aspect of this disclosure is an apparatus for transmitting power wirelessly. The apparatus comprises a detection circuit and a processor. The detection circuit is electrically coupled to a power amplifier driving an antenna circuit comprising one or more flexible antennas configured for wireless power transfer. The detection circuit is configured to measure at least one of the following variables: an impedance of the power amplifier, an output voltage of the power amplifier, and a current from the power amplifier. The processor is configured to determine that at least one of the variables falls outside of a corresponding threshold range, indicative of a deformation of a physical shape of at least one of the one or more flexible antennas or indicative of a misalignment of at least one of the one or more flexible antennas from a power receiver, associated with an operating condition of at least one of the one or more flexible antennas. The processor is further configured to command the power amplifier to transition to a first power mode from a second power mode based on the determination that at least one of the measured impedance, the measured voltage, and the measured current falls outside of the corresponding threshold range, the antenna circuit in the first power mode transmitting power at a power level less than the power level in the second power mode.

An aspect of this disclosure is a method of transmitting wireless power. The method comprises measuring at least one of the following variables: an impedance of a power amplifier that drives an antenna circuit comprising one or more flexible antennas configured for wireless power transfer, an output voltage of the power amplifier, and a current from the power amplifier. The method also comprises determining that at least one of the variables falls outside of a corresponding threshold range, indicative of a deformation of a physical shape of at least one of the one or more flexible antennas, or indicative of a misalignment of at least one of the one or more flexible antennas from a power receiver, associated with an operating condition of at least one of the one or more flexible antennas. The method further comprises commanding the power amplifier to transition to a first power mode from a second power mode based on the determination that at least one of the measured impedance, the measured voltage, and the measured current falls outside of the corresponding threshold range, the antenna circuit transmitting power in the first power mode at a power level less than the power level in the second power mode.

An aspect of this disclosure is another apparatus for transmitting wireless power. The apparatus comprises means for measuring at least one of the following variables: an impedance of a power amplifier that drives an antenna circuit comprising one or more flexible antennas configured for wireless power transfer, an output voltage of the power amplifier, and a current from the power amplifier. The apparatus further comprises means for determining that at least one of the variables falls outside of a corresponding threshold range, indicative of a deformation of a physical shape of at least one of the one or more flexible antennas, or indicative of a misalignment of at least one of the one or more flexible antennas from a power receiver, associated with an operating condition of at least one of the one or more flexible antennas. The apparatus also comprises means for commanding the power amplifier to transition to a first power mode from a second power mode based on the determination that at least one of the measured impedance, the measured voltage, and the measured current falls outside of the corresponding threshold range, the antenna circuit transmitting power in the first power mode at a power level less than the power level in the second power mode.

An additional aspect of this disclosure is a non-transitory, computer-readable storage medium comprising executable code. The medium comprises code to measure at least one of the following variables: an impedance of a power amplifier that drives an antenna circuit comprising one or more flexible antennas configured for wireless power transfer, an output voltage of the power amplifier, and a current from the power amplifier. The medium further comprises code to determine that at least one of the variables falls outside of a corresponding threshold range, indicative of a deformation of a physical shape of at least one of the one or more flexible antennas, or indicative of a misalignment of at least one of the one or more flexible antennas from a power receiver, associated with an operating condition of at least one of the one or more flexible antennas. The medium also comprises code to command the power amplifier to transition to a first power mode from a second power mode based on the determination that at least one of the measured impedance, the measured voltage, and the measured current falls outside of the corresponding threshold range, the antenna circuit transmitting power in the first power mode at a power level less than the power level in the second power mode.

### BRIEF DESCRIPTION OF THE DRAWINGS

Details of one or more implementations of the subject matter described in this specification are set forth in the accompanying drawings and the description below. Other features, aspects, and advantages will become apparent from the description, the drawings, and the claims.

FIG. 1 is a functional block diagram of a wireless power transfer system, in accordance with one exemplary implementation.

FIG. 2 is a functional block diagram of a wireless power transfer system, in accordance with another exemplary implementation.

FIG. 3 is a schematic diagram of a portion of transmit circuitry or receive circuitry of

FIG. 2 including a transmit or receive antenna, in accordance with exemplary implementations.

FIG. 4 is a diagram showing a wireless power transfer system as applied to a torso of a human body, in accordance with exemplary implementations of the invention.

FIG. 5 shows a view of the wireless power transfer system of FIG. 4 applying power to two (2) implant devices located within the torso of the human body of FIG. 4, in accordance with exemplary implementations of the invention.

FIG. 6A shows a flexible antenna in a substantially planar configuration, in accordance with exemplary implementations of the invention.

FIG. 6B shows a flexible antenna in a bent (non-planar) configuration, in accordance with exemplary implementations of the invention.

FIG. 7 is a simplified functional block diagram of a wireless power transmitter (PTU) that may be used in an inductive power transfer system, in accordance with exemplary implementations of the invention.

FIG. 8 is a simplified functional block diagram of a receiver (PRU) that may be used in the inductive power transfer system, in accordance with exemplary implementations of the invention.

FIG. 9A is a flowchart that includes a method for controlling the PTU of FIG. 7 based on an impedance of a driver circuit of the PTU, in accordance with exemplary implementations of the invention.

FIG. 9B is another flowchart of another method for controlling charging operations of the PTU of FIG. 7, in accordance with exemplary implementations of the invention.

FIG. 9C is another flowchart of another method for controlling charging operations of the PTU of FIG. 7, in accordance with exemplary implementations of the invention.

FIG. 9D is another flowchart of another method for controlling charging operations of the PTU of FIG.7, in accordance with exemplary implementations of the invention.

FIG. 10 is a flowchart that includes a plurality of steps of a method for transmitting wireless power to an implant or worn device via a power transmitter, in accordance with exemplary implementations of the invention.

The various features illustrated in the drawings may not be drawn to scale.

Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

The detailed description set forth below in connection with the appended drawings is intended as a description of exemplary implementations and is not intended to represent the only implementations in which the invention may be practiced. The term “exemplary” used throughout this description means “serving as an example, instance, or illustration,” and should not necessarily be construed as preferred or advantageous over other exemplary implementations. The detailed description includes specified details for the purpose of providing a thorough understanding of the exemplary implementations. In some instances, some devices are shown in block diagram form.

Wirelessly transferring power may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field) may be received, captured by, or coupled by a “receiving coil” to achieve power transfer.

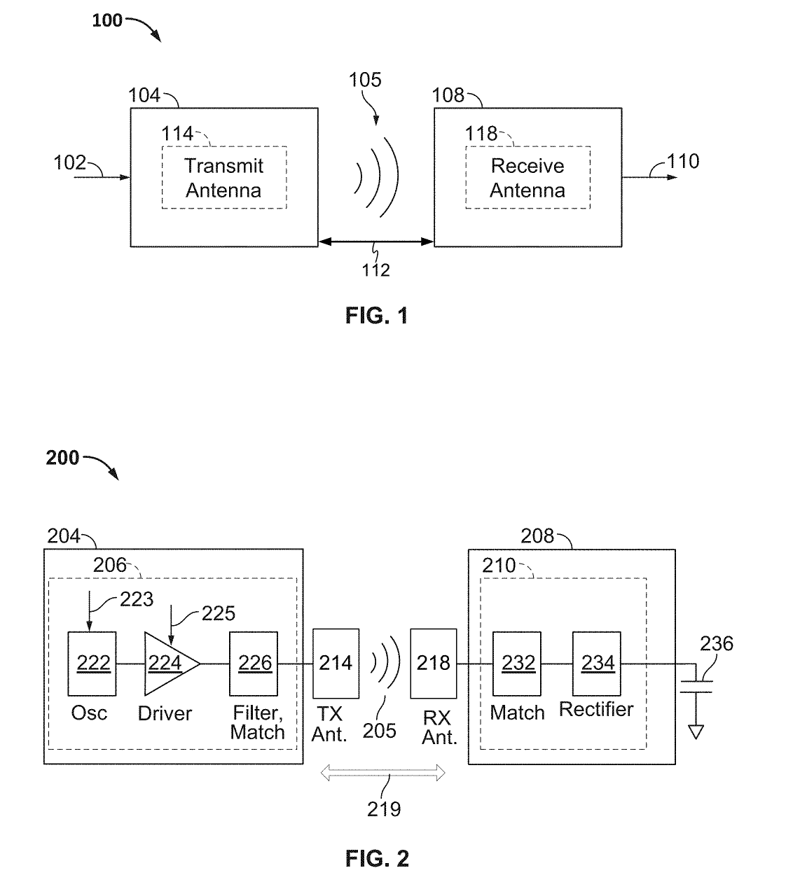

FIG. 1 is a functional block diagram of a wireless power transfer system 100, in accordance with one exemplary implementation. Input power 102 may be provided to a transmitter 104 from a power source (not shown) to generate a wireless (e.g., magnetic or electromagnetic) field 105 for performing wireless power transfer. A receiver 108 may couple to the wireless field 105 and generate output power 110 for storage or consumption by a device (not shown) coupled to the output power 110. Both the transmitter 104 and the receiver 108 are separated by a distance 112.

In one exemplary implementation, the transmitter 104 and the receiver 108 are configured according to a mutual resonant relationship. When the resonant frequency of the receiver 108 and the resonant frequency of the transmitter 104 are substantially the same or very close, transmission losses between the transmitter 104 and the receiver 108 are reduced. As such, wireless power transfer may be provided over a larger distance in contrast to purely inductive solutions that may require large antenna coils which are very close (e.g., sometimes within millimeters). Resonant inductive coupling techniques may thus allow for improved efficiency and power transfer over various distances and with a variety of inductive coil configurations.

The receiver 108 may receive power when the receiver 108 is located in the wireless field 105 produced by the transmitter 104. The wireless field 105 corresponds to a region where energy output by the transmitter 104 may be captured by the receiver 108. The wireless field 105 may correspond to the “near-field” of the transmitter 104 as will be further described below. The wireless field 105 may also operate over a longer distance than is considered “near field.” The transmitter 104 may include a transmit antenna 114 (e.g., a coil) for transmitting energy to the receiver 108. The receiver 108 may include a receive antenna or coil 118 for receiving or capturing energy transmitted from the transmitter 104. The near-field may correspond to a region in which there are strong reactance fields resulting from the currents and charges in the transmit antenna 114 that minimally radiate power away from the transmit antenna 114. The near-field may correspond to a region that is within about one wavelength (or a fraction thereof) of the transmit antenna 114.

FIG. 2 is a functional block diagram of a wireless power transfer system 200, in accordance with another exemplary implementation. The system 200 includes a transmitter 204 and a receiver 208. The transmitter 204 may include a transmit circuitry 206 that may include an oscillator 222, a driver circuit 224, and a filter and matching circuit 226. The oscillator 222 may be configured to generate a signal at a desired frequency that may be adjusted in response to a frequency control signal 223. The oscillator 222 may provide the oscillator signal to the driver circuit 224. The driver circuit 224 may be configured to drive the transmit antenna 214 at, for example, a resonant frequency of the transmit antenna 214 based on an input voltage signal (V_{D}) 225. The driver circuit 224 may be a switching amplifier configured to receive a square wave from the oscillator 222 and output a sine wave. For example, the driver circuit 224 may be a class E amplifier.

The filter and matching circuit 226 may filter out harmonics or other unwanted frequencies and match the impedance of the transmitter 204 to the impedance of the transmit antenna 214. As a result of driving the transmit antenna 214, the transmit antenna 214 may generate a wireless field 205 to wirelessly output power at a level sufficient for charging a battery 236.

The receiver 208 may include a receive circuitry 210 that may include a matching circuit 232 and a rectifier circuit 234. The matching circuit 232 may match the impedance of the receive circuitry 210 to the receive antenna 218. The rectifier circuit 234 may generate a direct current (DC) power output from an alternate current (AC) power input to charge the battery 236, as shown in FIG. 2. The receiver 208 and the transmitter 204 may additionally communicate on a separate communication channel 219 (e.g., Bluetooth, ZigBee, cellular, etc.). The receiver 208 and the transmitter 204 may alternatively communicate via in-band signaling using characteristics of the wireless field 205.

The receiver 208 may be configured to determine whether an amount of power transmitted by the transmitter 204 and received by the receiver 208 is appropriate for charging the battery 236.

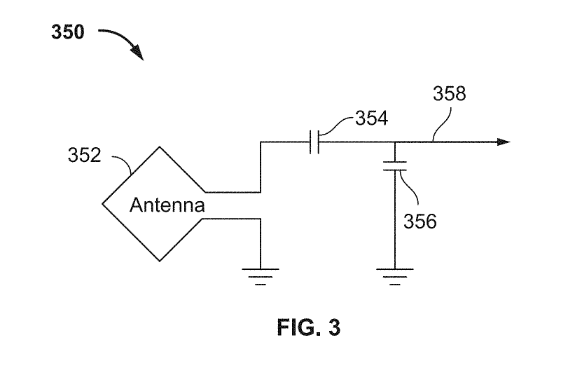

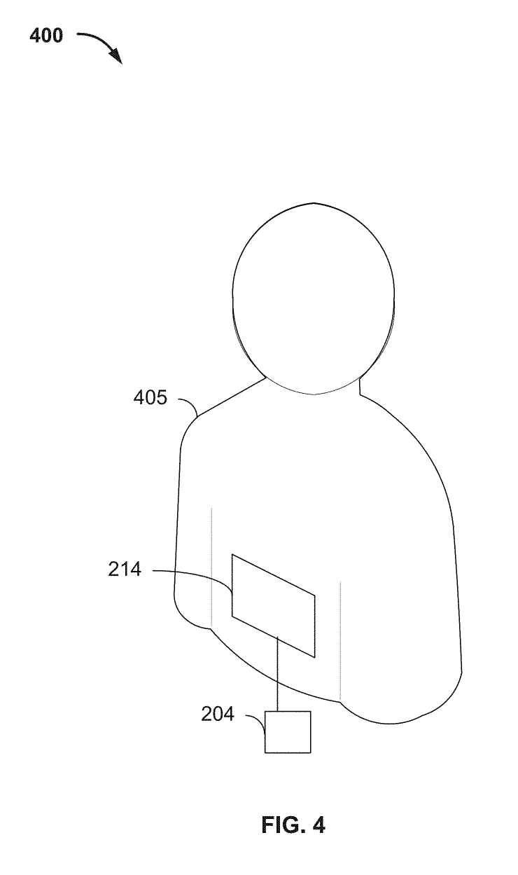

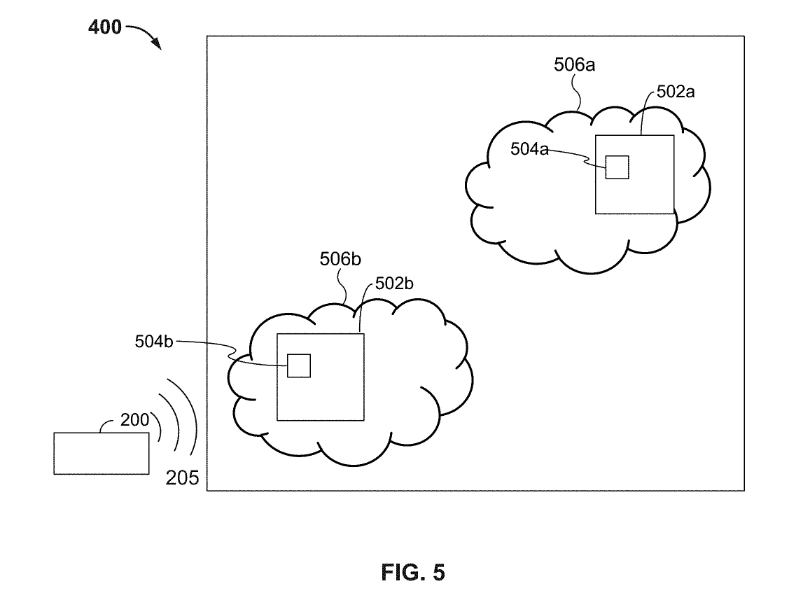

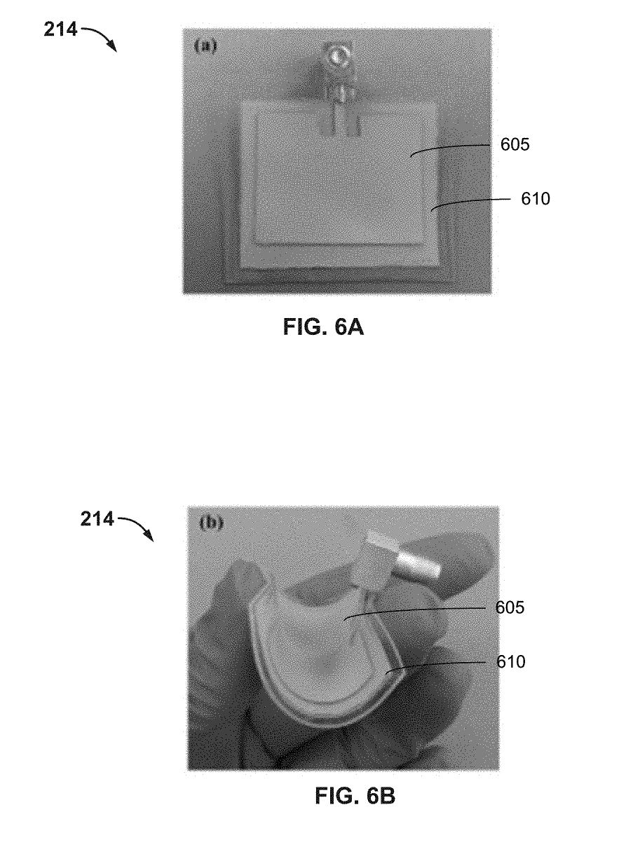

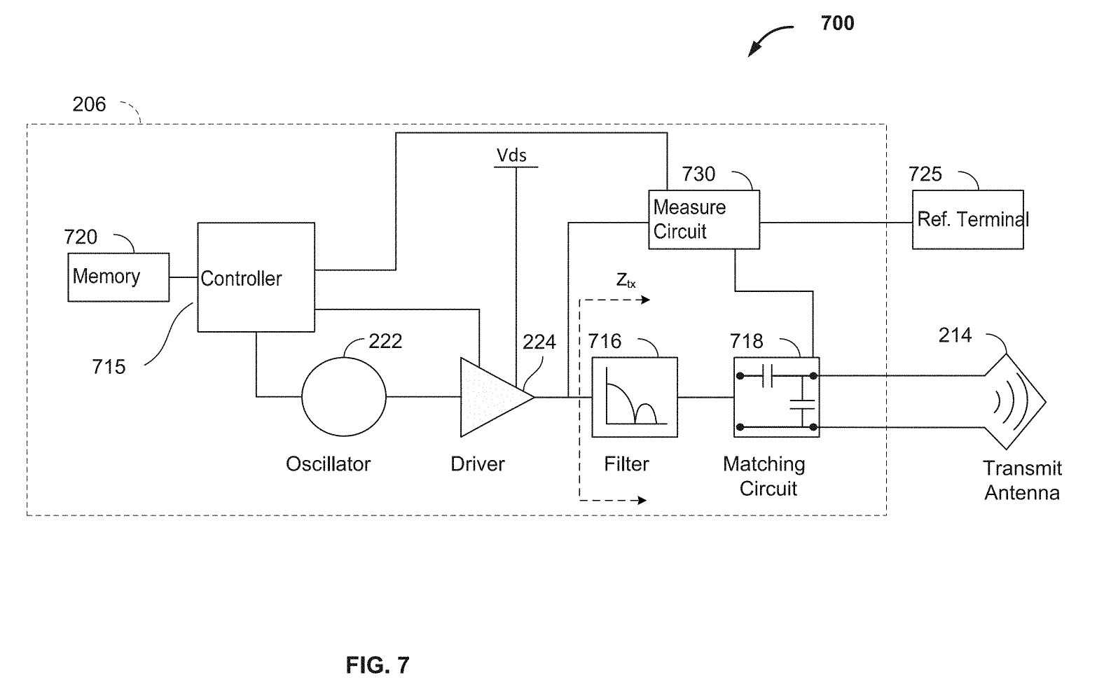

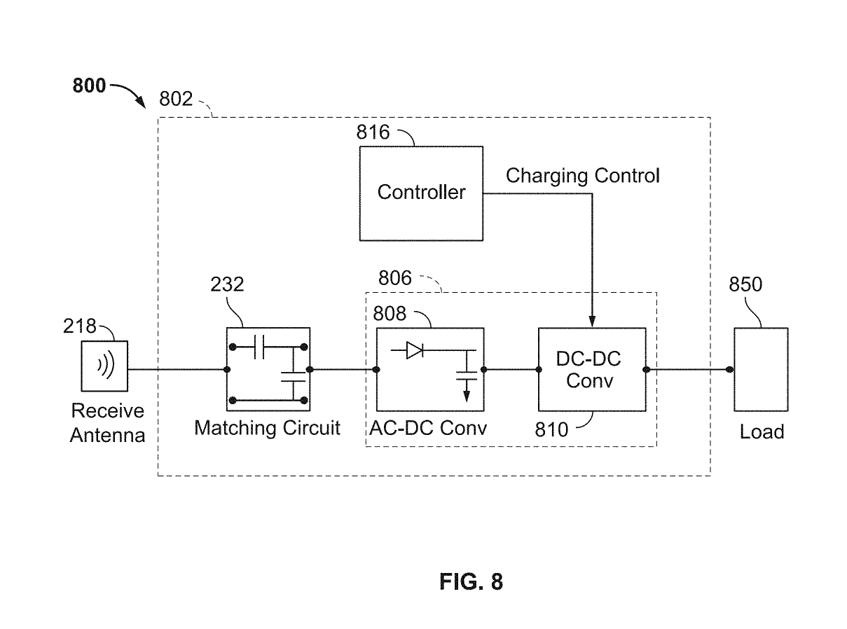

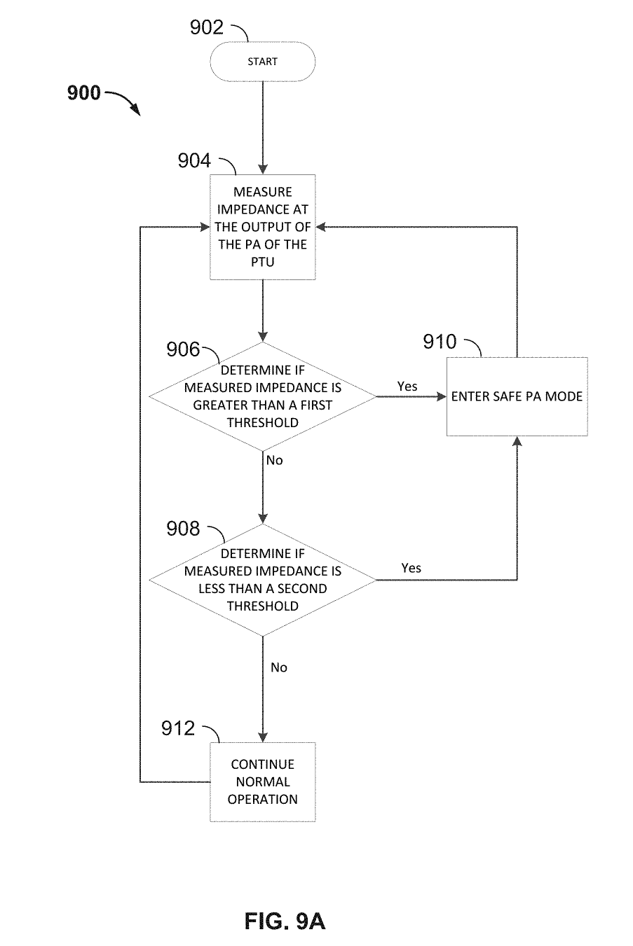

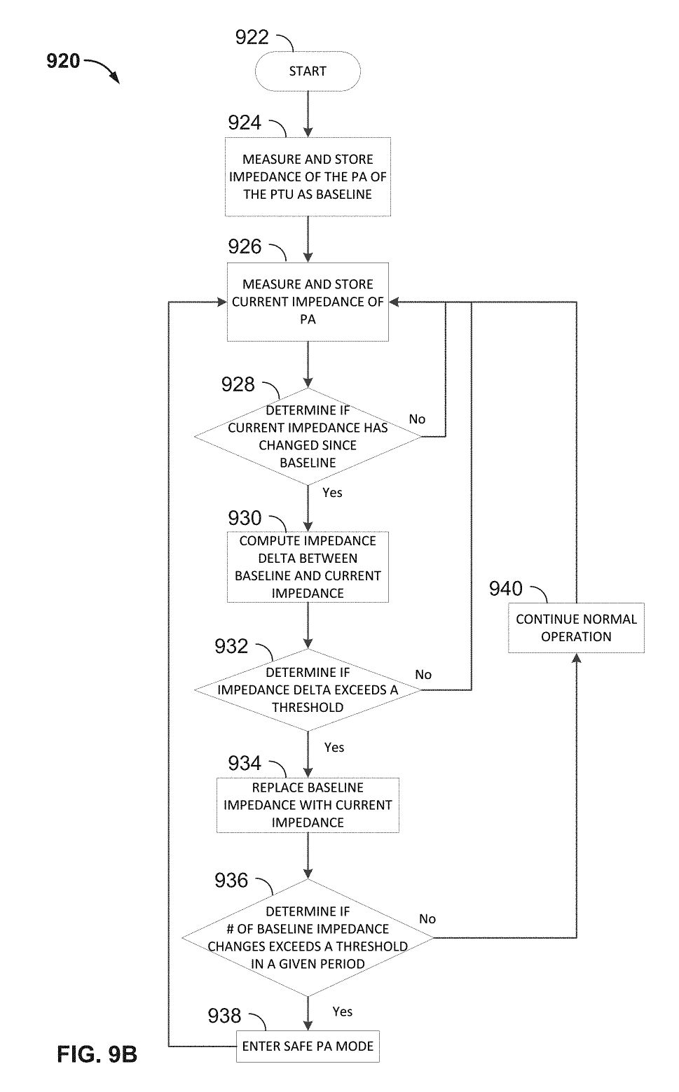

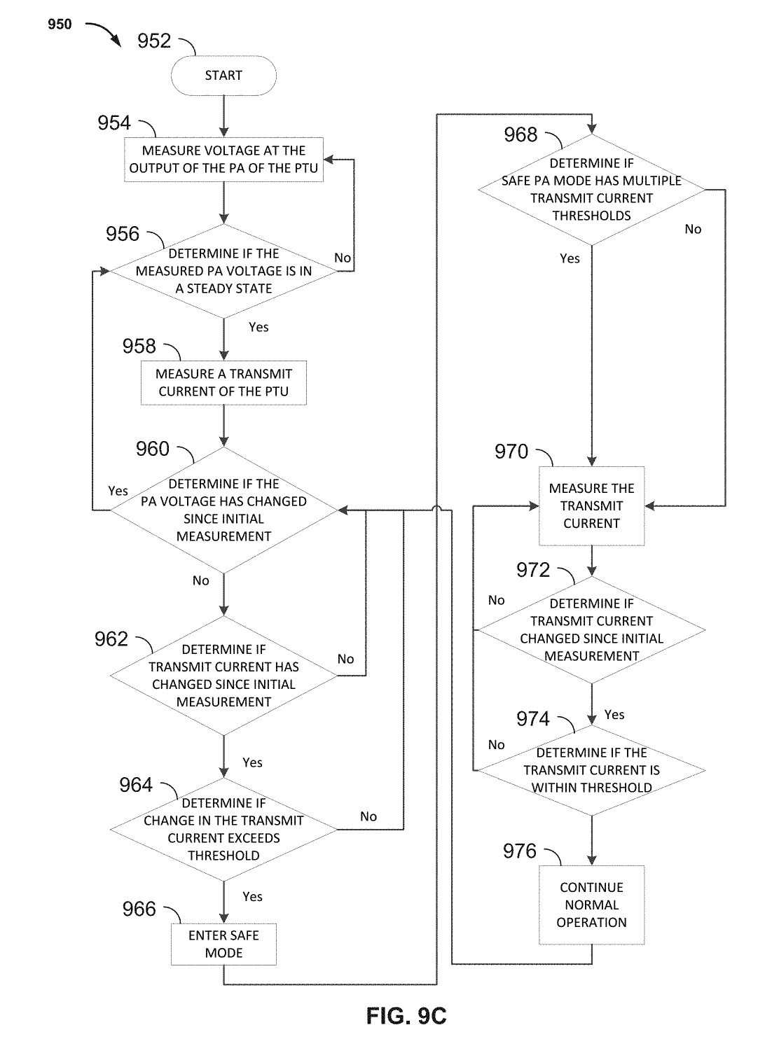

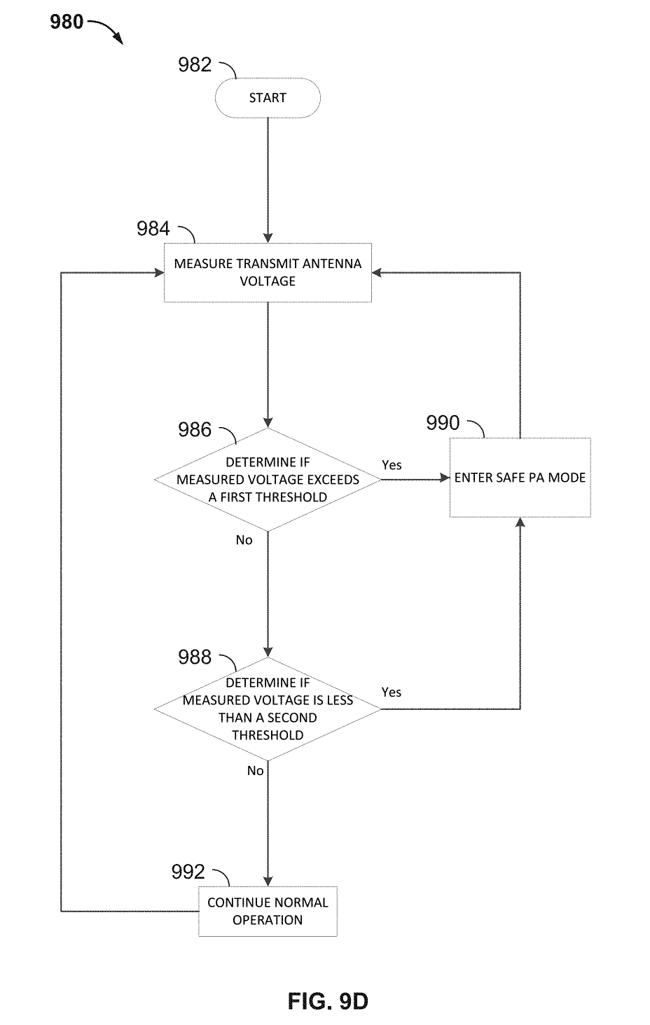

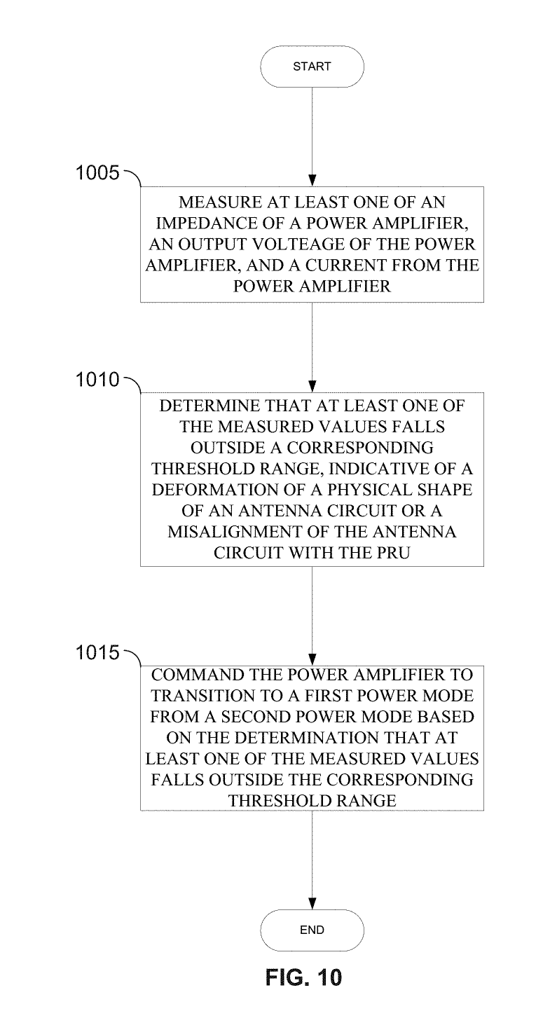

FIG. 3 is a schematic diagram of a portion of the transmit circuitry 206 or the receive circuitry 210 of FIG. 2 including a transmit or receive antenna, in accordance with exemplary implementations. As illustrated in FIG. 3, a transmit or receive circuitry 350 may include an antenna 352. The antenna 352 may also be referred to or be configured as a “loop” antenna 352. The antenna 352 may also be referred to herein or be configured as a “magnetic” antenna or an induction coil. The term “antenna” generally refers to a component that may wirelessly output or receive energy for coupling to another “antenna.” The antenna may also be referred to as a coil of a type that is configured to wirelessly output or receive power. As used herein, the antenna 352 is an example of a “power transfer component” of a type that is configured to wirelessly output and/or receive power.

The antenna 352 may include an air core or a physical core such as a ferrite core (not shown).

The transmit or receive circuitry 350 may form/include a resonant circuit. The resonant frequency of the loop or magnetic antennas is based on the inductance and capacitance. Inductance may be simply the inductance created by the antenna 352, whereas, capacitance may be added to the antenna's inductance to create a resonant structure at a desired resonant frequency. As a non-limiting example, a capacitor 354 and a capacitor 356 may be added to the transmit or receive circuitry 350 to create a resonant circuit. For a transmit circuitry, a signal 358 may be an input at a resonant frequency to cause the antenna 352 to generate a wireless field 105/205. For receive circuitry, the signal 358 may be an output to power or charge a load (not shown). For example, the load may comprise a wireless device configured to be charged by power received from the wireless field.

Other resonant circuits formed using other components are also possible. As another non-limiting example, a capacitor may be placed in parallel between the two terminals of the circuitry 350.

Referring to FIGS. 1 and 2, the transmitter 104/204 may output a time varying magnetic (or electromagnetic) field with a frequency corresponding to the resonant frequency of the transmit antenna 114/214. When the receiver 108/208 is within the wireless field 105/205, the time varying magnetic (or electromagnetic) field may induce a current in the receive antenna 118/218. As described above, if the receive antenna 118/218 is configured to resonate at the frequency of the transmit antenna 114/214, energy may be efficiently transferred. The AC signal induced in the receive antenna 118/218 may be rectified as described above to produce a DC signal that may be provided to charge or to power a load.

FIG. 4 is a diagram showing a wireless power transfer system 400 as applied to a torso 405 of a human body, in accordance with exemplary implementations of the invention. The system 400 includes a transmit antenna 214 (corresponding to transmit antenna 214 of FIG. 2) coupled to a transmitter 204 (corresponding to the transmitter 204 of FIG. 2). Though not shown in this figure, the transmitter 204 may be coupled to a transmit antenna circuit comprising one or more transmit antennas 214. The transmit antenna 214 is positioned on the torso 405 of the user's body and may wirelessly transfer power to an implant (not shown in this figure) on or within the user's body to charge or power the implant. Accordingly, the transmit antenna 214 may receive power from components of the transmitter 204 and transmit that power to the user's implant wirelessly. In some implementations, the transmitter 204 may be built into the same component/device as the antenna 214. In some implementations, the transmitter 204 may be a separate structural component than the transmit antenna 214 though they are electrically coupled.

FIG. 5 shows a view of the wireless power transfer system of FIG. 4 applying power to two (2) implant devices located within the torso of the human body of FIG. 4, in accordance with exemplary implementations of the invention. The system 400 includes the two implants 502a and 502b located within two regions or tissues of the torso 405. Each of the implants 502a and 502b may comprise internal circuit components 504a and 504b, respectively. The implants 502a and 502b may each further comprise a shield that protects the internal circuit components 504a and 504b from external interference or electrical signals or fields external to the implants 502a and 502b. In some embodiments, the internal circuit components 504a and 504b may each comprise a receiver (not shown) configured to receive power and/or data wirelessly from the transmit antenna 214 via the wireless field 205. In some embodiments, the respective receivers may be transceivers also configured to transmit power and/or data wirelessly from the implants 502a and 502b. In some embodiments, the receivers correspond to the receiver 208 of FIG. 2. In some implementations, the internal circuit components 504a and 504b of the implants 502a and 502b, respectively, may correspond to the load 236 of FIG. 2 when they receive power via the receivers.

The area of the torso 405 of the system 400 may be replaced by an area of any other living body within which one or more functions may be desired to be monitored or controlled. In the area of the torso 405 as depicted in FIG. 5, the implants 502a and 502b (e.g., comprising various electronic devices) may control or monitor various functions, signals, or conditions of the body.

The implants 502a and 502b may allow for the diagnosis and/or treatment of diseases and/or various other conditions. In some embodiments, the implants 502 may be used for medical “neuromodulation,” where the implants 502 attach to nerves of the body and monitor or stimulate the nerves to which they are attached. In some embodiments, the implants 502 may control or regulate a status or a chemical value (e.g., control an introduction of a chemical) of the body. For example, the implants 502 may monitor a brain or nervous system and deliver electrical stimulation or medication to relieve pain and/or restore functions. Alternatively, or additionally, the implants 502 may comprise insulin monitors, insulin injectors, hearing aids, or pacemakers, among other implanted or wearable devices.

In some embodiments, the implants 502 may utilize primary batteries as a power source. However, as the batteries require replacement, replacement of the batteries in the implants 502 may require surgery to perform the replacement. Accordingly, alternate, or additional, methods of powering the implants 502 are desired. Wireless charging and/or power transfer may provide a safer and less invasive method of powering such implants 502 in the long term. The transmit antenna 214 may transfer power wirelessly via the wireless field 205 to charge or power the internal circuit components 504a and 504b of such implants 502 via their respective receivers.

FIG. 6A shows a flexible antenna in a substantially planar configuration, in accordance with exemplary implementations of the invention. In some implementations, the substantially planar configuration may be positioned in relation to the user's body (e.g., the torso 405 of FIG. 4). The flexible antenna 214 may correspond to the transmit antenna 214 of FIG. 2. As noted above, one or more flexible antenna 214 may form a transmit circuit. The flexible antenna 214 comprises a conductor 605 and a substrate 610. The conductor 605 may comprise any conductive material generally used to wirelessly transfer power and/or communications. The substrate 610 may comprise a material (e.g., a non-conductive material when in direct contact with the conductor 605) upon which or within which the conductor 605 is disposed. For example, the substrate 610 may be a fabric, leather, plastic, or other material that may be worn by the user or positioned on the user's body. In some implementations, the conductor 605 and the substrate 610 may be positioned on the user's body such that at least a portion of the conductor 605 is exposed to (e.g., in direct contact with) the user's body.

The substantially planar configuration may be any shape, orientation, position, etc., of the flexible antenna 214 in relation to the user's body when the flexible antenna 214 is coupled to the transmitter (e.g., the transmitter 204 of FIG. 2). In some implementations, the shape, orientation, position, etc., of the flexible antenna 214 may be dynamic based on the movement. For example, one or more of the shape, orientation, and position of the flexible antenna 214 may be distorted by the movement. In some implementations, the orientation and/or position of the flexible antenna 214 may correspond to the flexible antenna 214 being misaligned in relation to the PRU. For purposes of simplified discussion, only distortions of one of the shape, position, or orientation may be used for purposes of discussion and examples, though the corresponding discussion may apply to any of these. When in the substantially planar shape, no portion of the user's body may be subjected to higher than acceptable magnetic field levels and no component of the transmitter 204 may be subject to overheating, etc. Accordingly, the transmitter 204 coupled to the flexible antenna 214 may be permitted to continue operation (e.g., wireless power transfer) when the flexible antenna 214 is in the substantially planar configuration.

FIG. 6B shows a flexible antenna in a bent (non-planar) configuration, in accordance with exemplary implementations of the invention. In some implementations, the substantially nonplanar configuration may be a result of the substantially planar configuration of FIG. 6B being distorted in one or more of shape, orientation, position, etc., in relation to the user's body. The flexible antenna 214 as distorted into the substantially nonplanar configuration may subject a portion of the user's body to higher than acceptable magnetic field levels or cause one or more components of the transmitter 204 to overheat, etc.

As noted above, the impedance of the flexible antenna 214 may change as the flexible antenna 214 shape distorts. Accordingly, the transmitter 204 may measure the impedance of the flexible antenna 214 at the output of a driver or power amplifier (PA) of the transmitter 204 (e.g., the driver 224) that is operationally coupled to the flexible antenna 214. The transmitter 204 may determine distortions in the shape of the flexible antenna 214 based on changes of the measured impedance. For example, the flexible antenna 214 in the shape of FIG. 6A may have an impedance value of a first level. The first impedance level may correspond to a shape with which the flexible antenna 214 generally transmits power to the implant device with a first efficiency level. For example, when the flexible antenna 214 is positioned along the user's back, the flexible antenna 214 may be substantially planar, as shown in FIG. 6A, and transmit power with the first efficiency level. In another example, the first impedance level may correspond to a shape with which the flexible antenna 214 generally transmits power with a specific absorption rate (SAR) that is different than the corresponding efficiency level. The flexible antenna 214 may change the first impedance level by 10% while changing the efficiency level within an acceptable range. However, the SAR level for the same impedance and efficiency level may be outside acceptable limits. Accordingly, the SAR may be used to control operation in conjunction with the efficiency and impedance.

On the other hand, when the flexible antenna 214 is placed in a shape that is dangerous for either the transmitter 204 or the user, the transmitter 204 may measure the impedance of the driver 224 as being at a second level. The second level impedance may have a higher or lower value than the first impedance level. Both higher and lower impedance values may be harmful dependent on the delta between the higher or lower impedance value and the first impedance level. The second level impedance may correspond to the shape with which the flexible antenna 214 generally transmits power to the implant device 502a and 502b (FIG. 5) with a second efficiency level that is lower than the first efficiency level at the first impedance level. For example, when the flexible antenna 214 is folded, twisted, bent, or otherwise substantially nonplanar, as shown in FIG. 6B, the efficiency level may be lower than when the flexible antenna 214 is substantially planar.

FIG. 7 is a simplified functional block diagram of a wireless power transmitter (PTU) that may be used in an inductive power transfer system, in accordance with exemplary implementations of the invention. As shown in FIG. 7, the transmitter (PTU) 700 includes transmit circuitry 206 and a transmit antenna 214 operably coupled to the transmit circuitry 206. The transmit antenna 214 may be configured as the transmit antenna 214 as described above in reference to FIG. 2 or the flexible antenna 214 of FIGS. 6A-6C. In some implementations, the transmit antenna 214 may be a coil (e.g., an induction coil). In some implementations, the transmit antenna 214 may be associated with a larger structure, such as a table, mat, lamp, or other stationary configuration. The transmit antenna 214 may be configured to generate an electromagnetic or magnetic field. In an exemplary implementation, the transmit antenna 214 may be configured to transmit power to a receiver device within a charging region at a power level sufficient to charge or power the receiver device (e.g., PRU).

The transmit circuitry 206 may receive power through a number of power sources (not shown). The transmit circuitry 206 may include various components configured to drive the transmit antenna 214. In some exemplary implementations, the transmit circuitry 206 may be configured to adjust the transmission of wireless power based on the presence and constitution of the receiver devices as described herein. As such, the PTU 700 may provide wireless power efficiently and safely.

The transmit circuitry 206 may further include a controller 715. In some implementations, the controller 715 may be a micro-controller. In other implementations, the controller 715 may be implemented as an application-specified integrated circuit (ASIC). The controller 715 may be operably connected, directly or indirectly, to each component of the transmit circuitry 206. The controller 715 may be further configured to receive information from each of the components of the transmit circuitry 206 and perform calculations based on the received information. The controller 715 may be configured to generate control signals for each of the components that may adjust the operation of that component. As such, the controller 715 may be configured to adjust the power transfer based on a result of the calculations performed by it.

The transmit circuitry 206 may further include a memory 720 operably connected to the controller 715. The memory 720 may comprise random-access memory (RAM), electrically erasable programmable read only memory (EEPROM), flash memory, or non-volatile RAM. The memory 720 may be configured to temporarily or permanently store data for use in read and write operations performed by the controller 715. For example, the memory 720 may be configured to store data generated as a result of the calculations of the controller 715. As such, the memory 720 allows the controller 715 to adjust the transmit circuitry 206 based on changes in the data over time. In some implementations, the memory 720 stores measurements made by one or more components of the transmit circuitry 206. In some implementations, the memory 720 may include data formatted as lookup tables.

The transmit circuitry 206 may further include an oscillator 222 operably connected to the controller 715. The oscillator 222 may be configured as the oscillator 222 as described above in reference to FIG. 2. The oscillator 222 may be configured to generate an oscillating signal (e.g., radio frequency (RF) signal) at the operating frequency of the wireless power transfer. In some exemplary implementations, the oscillator 222 may be configured to operate at the 6.78 MHz ISM frequency band. The controller 715 may be configured to selectively enable the oscillator 222 during a transmit phase (or duty cycle). The controller 715 may be further configured to adjust the frequency or a phase of the oscillator 222 which may reduce out-of-band emissions, especially when transitioning from one frequency to another. As described above, the transmit circuitry 206 may be configured to provide an amount of power to the transmit antenna 214, which may generate energy (e.g., magnetic flux) about the transmit antenna 214.

The transmit circuitry 206 may further include a driver circuit 714 operably connected to the controller 715 and the oscillator 222. The driver circuit 714 may be configured as the driver circuit 224 as described above in reference to FIG. 2. The driver circuit 714 may be configured to drive the signals received from the oscillator 222, as described above.

The transmit circuitry 206 may further include a low pass filter (LPF) 716 operably connected to the transmit antenna 214. The low pass filter 716 may be configured as the filter portion of the filter and matching circuit 226 as described above in reference to FIG. 2. In some exemplary implementations, the low pass filter 716 may be configured to receive and filter an analog signal of current and an analog signal of voltage generated by the driver circuit 714. The analog signal of current may comprise a time-varying current signal, while the analog signal of current may comprise a time-varying voltage signal. In some implementations, the low pass filter 716 may alter a phase of the analog signals. The low pass filter 716 may cause the same amount of phase change for both the current and the voltage, canceling out the changes. In some implementations, the controller 715 may be configured to compensate for the phase change caused by the low pass filter 716. The low pass filter 716 may be configured to reduce harmonic emissions to levels that may prevent self-jamming. Other exemplary implementations may include different filter topologies, such as notch filters that attenuate specified frequencies while passing others.

The transmit circuitry 206 may further include a fixed impedance matching circuit 718 operably connected to the low pass filter 716 and the transmit antenna 214. The matching circuit 718 may be configured as the matching portion of the filter and matching circuit 226 as described above in reference to FIG. 2. The matching circuit 718 may be configured to match the impedance of the transmit circuitry 206 (e.g., 50 ohms) to the transmit antenna 214. Other exemplary implementations may include an adaptive impedance match that may be varied based on measurable transmit metrics, such as the measured output power to the transmit antenna 214 or a DC current of the driver circuit 714.

The transmit circuitry 206 may be further coupled to a reference terminal 725. The reference terminal 725 may comprise a conductive terminal that is operationally coupled to the controller 715. In some implementations, the reference terminal is coupled to a measurement circuit 730 (described in further detail below). The reference terminal may provide a reference value measurable by the controller 715. In some implementations, the reference terminal 725 may be used when measuring voltages across the transmit antenna 214. For example, a voltage across one terminal of the transmit antenna 214 (or of the driver circuit 224) and the reference terminal 725 may be measured and compared to a voltage across a second terminal of the transmit antenna 214 (or of the driver circuit 224) and the reference terminal 725. The reference terminal could be a large conductive or semi-conductive pad in close contact with the skin.

The transmit circuitry 206 may further include the measurement circuit 730 operably connected to the output of the driver circuit 224, the reference terminal 725, and the controller 715. In some implementations, the measurement circuit 730 measures one or more parameters of one or more components of the PTU 700 and communicate the one or more parameters to the controller 715. For example, the measurement circuit 730 measures an impedance Zₜₓ of the transmit antenna 214 as seen at the output of the driver circuit 224, as shown in FIG. 7, and communicates the impedance to the controller 715. Other exemplary implementations may include an ability to measure voltage(s) Vₜₓ across the transmit antenna 214 and/or to measure voltages between each terminal of the transmit antenna 214 (shown as coupled at the matching circuit 718) and the reference terminal 725, and communicate the voltage(s) Vₜₓ to the controller 715. In some implementations, the measurement circuit 730 measures a current. Iₜₓ of the transmit antenna 214 and communicates the current Iₜₓ to the controller 715. In some implementations, the measurement circuit 730 may receive commands from the controller 715 that instruct when and which of the one or more parameters to measure. In some implementations, the measurement circuit 730 will communicate measurements to other components of the PTU 700. The transmit circuitry 206 may further comprise discrete devices, discrete circuits, and/or an integrated assembly of components. The measurement circuit 630 may read the impedance Zₜₓ, the voltage Vₜₓ, the current Iₜₓ and the phase difference between the voltage Vₜₓ and the current Iₜₓ individually or in combination. The measurement circuit 630 may also measure the phase difference between the phase of voltage Vₜₓ or the current Iₜₓ and the phase of oscillator 222.

In measuring the impedance at the driver circuit 224, the measuring circuit 730 (or other measuring component) of the PTU 700 may actively detect and measure the impedance and, accordingly, determine when the PTU 700 (e.g., the PA) is loaded by a PRU and to regulate the transmit antenna's current set point. Accordingly, the active detection and measurements may also be useful to periodically and/or continuously measure the driver circuit 714 output impedance. For example, in some implementations the measuring circuit 730 may periodically measure its driver circuit 714 output impedance at intervals based on an elapsed timer. In some implementations, the measuring circuit 730 may periodically measure the driver circuit output impedance based on detecting one or more conditions of the PTU 700 (e.g., communication from the implant, increase in temperature, user input, change in environmental conditions, sensor changes, etc.). In some implementations, the measuring circuit 730 may continuously measure the driver circuit output impedance to enable prompt resolution of any impedance change.

In some implementations, one or more sensors or measurement devices (not shown) may measure the one or more parameters of the components of the PTU 700 instead of or in addition to the measurement circuit 730. Once the one or more parameters of the components of the PTU 700 are measured, the controller 715 may receive the one or more parameters. In some implementations, the measurement circuit 730 communicates the one or more parameters to another controller or comparison component (not shown).

Transmit antenna 214 may be implemented as an antenna strip with the thickness, width and metal type selected to keep resistance losses low.

The PTU 700 may further include one or more user interface components (e.g., a screen, audible sound generate, physical feedback, etc.) by which the PTU 700 may communicate with the user.

In some implementations, the PTU 700 (or at least the transmit antenna 214 of the PTU 700) may be manufactured to be comfortable and desirable to wear. For example, the transmit antenna 214 may be flexible and/or integrated into an article of clothing or accessory that a user may wear. Thus, the flexible transmit antenna 214 may be integrated into a shirt or a belt or similar band that is worn around a portion of the user's body. In some implementations, the flexible transmit antenna 214 may be integrated into a purse, a backpack, or similar case such that the flexible transmit antenna 214 is in close proximity with a user's body. The flexible transmit antenna 214 integrated into clothing may enable the user to maintain proximity between the transmit antenna 214 and the PRU (e.g., a receive antenna of the PRU) of a device implanted in the user's body. Accordingly, the PTU 700 may transmit power to the PRU while the user is wearing the transmit antenna 214, providing for wireless charging while the user is moving and changing positions, allowing the user to maintain mobility.

However, as the transmit antenna 214 changes shape (e.g., in relation to the PRU or the implanted device), the one or more parameters and/or magnetic field output pattern of the transmit antenna 214 may be different for each of the shapes, positions, and/or orientations. Accordingly, an efficiency in power transfer from the transmit antenna 214 to the PRU may change as the one or more parameters and/or magnetic field output pattern changes. Thus, it is desirable to avoid operation of the PTU 700 when the one or more parameters the magnetic field pattern of the transmit antenna 214 are outside of corresponding threshold ranges and.

For example, the change in the shape of the transmit antenna 214 may cause the PTU 700 to operate in a sub-optimal or even unsafe operating condition. For example, when transferring power at low efficiencies, one or more of the components of the PTU 700, for example the driver circuit 224, may work harder. Accordingly, the one or more components of the PTU 700 may overheat based on a shape of the transmit antenna 214. This heat may also adversely impact the user (e.g., create a burn or irritation). On the other hand, the change in the magnetic field pattern may expose a portion of the user's body (or any external body) to higher than acceptable levels of the magnetic field (e.g., specific absorption rate (SAR) limits may exceed desired limits). In some implementations, coupling between the PTU 700 and the PRU may change as result of the change in shape of the transmit antenna 214. Accordingly, the shape of the transmit antenna 214 may impact charging rates and parameters between the PTU 700 and the PRU and may create instability or other issues with one or both of the PTU 700 and the PRU.

The PTU 700 may control its charging capabilities and configuration based on the shape (and distortions during operation) and/or alignment of the transmit antenna 214. Since the one or more parameters of the PTU 700 may change as the shape or alignment of the transmit antenna 214 changes (e.g., distorts), in some implementations, the one or more parameters of the PTU 700 can be used to monitor the shape, position, and/or orientation of the transmit antenna 214. For example, if the transmit antenna 214 is determined to be distorted, but all of the PRUs still have a good voltage, safe operating limits are not exceeded and the impedance is within range, the PTU 700 may continue charging the PRUs even from the distorted shape. Additionally, the one or more parameters of one or more other components of the PTU 700 may be used to monitor the position and/or orientation of the transmit antenna 214 in relation to the skin of the user. These examples of monitoring may be used in conjunction with controlling the capabilities and configuration of the PTU 700 while maintaining safety and comfort of the user (as opposed to thermal or radiation type sensors to detect poor conditions).

The controller 715 (or other controller or component of the PTU 700) may compare the one or more parameters with values stored in the memory 720. In some implementations, the controller 715 may utilize a lookup table or other memory structure that associates the one or more parameters with one of operational limits and thresholds or the shape, position, and/or orientation of the transmit antenna 214 or of the PTU 700. In some implementations, the lookup tables include one or more values.

For example, a first lookup table may include a baseline parameter (corresponding to at least one of the one or more parameters) and one or more corresponding operational limits, thresholds, or ranges (e.g., impedance Zₜₓ limits, voltage Vₜₓ limits, or current Iₜₓ limits). The first lookup table may be generated when the PTU 700 is manufactured based on calculated acceptable operational ranges given particular baseline parameter values. Alternatively or additionally, the first lookup table may be updated after the PTU 700 is manufactured, for example during maintenance or installation, etc. As described below, the controller 715 may use the first lookup table to control operation of the PTU 700.

The controller 715 may measure one or more of the baseline parameters (e.g., measure one or more of the impedance Zₜₓ, voltage Vₜₓ, and current Iₜₓ) when the PTU 700 is initially activated or in response to a user reset or request. The controller 715 may then use the baseline parameter(s) to identify operational limits corresponding to the baseline parameter from the lookup table for use in controlling operation of the PTU 700. During operation, the controller 715 may continue to monitor and measure the one or more parameters in relation to the limits based on the baseline parameter(s). For example, the controller 715 may measure the one or more parameters and determine that the shape is distorted or the alignment disrupted based on the measured parameters falling outside of the threshold limits based on the baseline parameter(s). The controller 715 may utilize the limits to control operation of the PTU 700, for example, entering a low or reduced power (e.g., safe) mode when one or more of the measured parameters exceeds the corresponding limit or threshold or falls outside the corresponding limits or thresholds. In some implementations, the reduced power mode may reduce power transmission to zero (e.g., terminate or shut down power transmission by the PTU 700). In some implementations, the reduced power mode may reduce the power transmission rate to a level less than a normal operation mode, at which the PTU 700 may operate when the one or more measured parameters are within corresponding operational limits.

In another example, a second lookup table may include the one or more parameters and one or more corresponding shapes, positions, and/or orientations of the transmit antenna 214 for the given one or more parameters. The second lookup table may be generated when the PTU 700 is manufactured based on identified shapes, positions, and/or orientations of the transmit antenna 214 at different values of the respective one or more parameters. Alternatively or additionally, the second lookup table may be updated after the PTU 700 is manufactured, for example during maintenance or installation, etc. In operation, the controller 715 may measure the one or more parameters (e.g., measure values of the one or more parameters). Based on the one or more measured parameters, the controller 715 may compare the one or more measured parameters with the lookup table to determine which shape, position, and/or orientation of the transmit antenna 214 would result in the one or more measured parameters. Accordingly, based on the comparison of the one or more measured parameters with the lookup table, the controller 715 may determine the shape (and/or position and/or orientation) of the transmit antenna 214. For example, the controller 715 may measure the one or more parameters and determine from the second lookup table that the shape is distorted or the alignment disrupted based on the measured parameters. In some implementations, the thresholds or limits discussed herein may correspond to or determine whether the transmit antenna 214 is distorted or misaligned in relation to the PRU.

For example, when the one or more parameters, for example, the impedance Zₜₓ is measured as having a first value, the controller 715 may determine from the second lookup table that the transmit antenna 214 is bent at a first angle or is positioned in a first location in relation to the PRU. On the other hand, when the one or more parameters, for example, the impedance Zₜₓ is measured as having a second value, the controller 715 may determine from the second lookup table that the transmit antenna 214 is bent at a second angle or is positioned in a second location in relation to the PRU. When the first value is less than the second value, then the first angle may be smaller than the second angle. Accordingly, the controller 715 may utilize the one or more measured parameters to determine the shape, position, and/or orientation of the transmit antenna 214 and may control operation of the PTU based on the second lookup table.

In some implementations, the PTU 700 may control its charging capabilities and configuration based on a rate of temperature rise in the PTU 700 (e.g., specifically monitored at the PA or a filter (not shown) of the PTU 700). If the monitored rate of temperature change significantly rises in magnitude or rate of change when the rate of temperature change is expected to remain steady or decrease, then this sudden increase in rate of temperature rise of the PTU 700 may indicate a distorted antenna. In some implementations, the controller 715 may compare the rate of temperature change to one or more temperature change threshold values to determine if the rate of temperature change is within a threshold range. Such a threshold range may be stored in the memory 720 or received from an external device or user set. Alternatively, or additionally, if a current in the flexible antenna 600 of the PTU 700 suddenly changes, this sudden change in the current may indicate a distorted antenna. In some implementations, the controller 715 may compare the transmit current to one or more transmit current threshold values to determine if the transmit current is within a threshold range. Such a threshold range may be stored in the memory 720 or received from an external device or user set. In some implementations, a system efficiency (e.g., power transfer efficiency between the PTU 700 and the PRU 800) or a power into the PA of the PTU 700 changes suddenly, such a sudden change may also indicate a distorted antenna of the PTU 700. In some implementations, the controller 715 may compare the system efficiency to one or more system efficiency threshold values to determine if the system efficiency is within a threshold range. Such a threshold range may be stored in the memory 720 or received from an external device or user set. Additionally, if an input voltage and/or an output current of the PA of the PTU 700 changes suddenly without the PTU controller 715 requesting or commanding such a change, such changes in one or more of the input voltage and the output current of the PA of the PTU 700 may be due to a distortion of the antenna. In some implementations, the controller 715 may compare the input voltage and/or output current to one or more input voltage and/or output current threshold values to determine if the input voltage and/or output current is within a threshold range. Such a threshold range may be stored in the memory 720 or received from an external device or user set.

Based on the lookup table (e.g., first or second lookup tables), the controller 715 (or other controller or component) may cause one or more of the components of the PTU 700 to alter or stop its operation, thereby altering or stopping the power transmission by the transmit antenna 214. For example, the controller 715 may alter the power transmission by the transmit antenna 214 when one or more of the impedance Zₜₓ, voltage Vₜₓ, and current Iₜₓ are within the limits or thresholds associated with the baseline parameter as opposed to outside the limits or thresholds. In some implementations, the associated limits or thresholds of the first lookup table may prevent unsafe operation while maximizing efficiency (e.g., ensuring parameters are within efficient limits). In some implementations, the corresponding limits may be respective of thresholds within which each of the one or more parameters varies during operation. In some implementations, an amount of altering of the power transmission may depend, at least in part, on the one or more parameters in relation to the limits, where the greater the difference, the greater the amount of altering. Accordingly, in some implementations, an action the controller 715 takes in response to a change in the one or more parameters may depend, at least in part, on whether the one or more parameter indicates efficient power transfer between the transmit antenna 214 and the PRU 800.

Additionally or alternatively, the controller 715 may alter the power transmission by the transmit antenna 214 based on the shape of the transmit antenna. For example, the controller 715 may alter the power transmission by the transmit antenna 214 when one or more of the impedance Zₜₓ, voltage Vₜₓ, and current Iₜₓ indicate that the transmit antenna is in a particular shape, position, and/or orientation. In some implementations, the associated shapes of the second lookup table may prevent unsafe operation while maximizing efficiency (e.g., ensuring parameters represent efficient shapes, positions, and/or orientations). In some implementations, an amount of altering of the power transmission may depend, at least in part, on the effect of the shape of the transmit antenna 214, where the greater the effect, the greater the power transmission is altered, and vice versa. Accordingly, in some implementations, an action the controller 715 takes in response to a change in the shape may depend, at least in part, on the effect the new shape has on the power transfer between the transmit antenna 214 and the PRU 800. For example, the controller 715 may determine that the transmit antenna 214 is folded in half or curved around itself such that it overlaps with itself, etc. based on a particular impedance value.

Accordingly, the action taken by the controller 715 may depend in part on the one or more parameters of the components of the PTU 700 or the shape of the transmit antenna 214. For example, the controller 715 may terminate or pause wireless power transfer to any PRU 800 when the limits of the first lookup table are exceeded or when the shape of the transmit antenna 214 is not optimized, per the second lookup table (e.g., not providing wireless power transfer at a highest possible efficiency for the pair of the PTU 700 and the PRU 800). By measuring the one or more parameters as the shape of the transmit antenna 214 contorts and/or changes and moves with and in relation to the user's body, the controller 715 can detect distortions in the shape of the transmit antenna 214 and may control a charging state of the PTU 700 accordingly.

In some implementations, the reference terminal 725 may be used in conjunction with the one or more parameters of the PTU 700. For example, the inclusion of the reference terminal 725 with the impedance Zₜₓ of the driver circuit 224 may indicate a distance between the transmit antenna 214 and the skin of the user's body. In some implementations, the reference terminal 725 may be placed in contact with the skin of the user's body (e.g., torso 405). The capacitive coupling between the reference terminal 725 and the transmit antenna 214 may approximately indicate a distance from the transmit antenna 214 to the user's skin. For example, if all aspects are ideal, then the capacitive coupling between the two structures may accurately indicate distance from each terminal to the skin. However, aspects such as skin moisture content, changes in skin dielectric constant, and distortion of the reference terminal may degrade an accuracy of the measurement. If the capacitive coupling is lower than a threshold value, then the transmit antenna is determined, by the controller 715, to be too far (or of a poor shape, position, and/or orientation) in relation to the user's skin to effectively transfer power and/or communications to the implants 502a and 502b (FIG. 5). Accordingly, the PTU 700 may reduce or suspend charging (e.g., enter the safe mode) and notify the user to re-position the transmit antenna 214 (e.g., as integrated into a charging garment, accessory, etc.) or the reference terminal 725.

In some implementations, the PTU 700 and the controller 715 may indicate to the user, via the user interface, that the transmit antenna 214 is in a poor charging position based on at least one of the one or more parameters.

FIG. 8 is a block diagram of a receiver, in accordance with an implementation of the present invention. As shown in FIG. 8, a receiver 800 includes a receive circuitry 802, a receive antenna 804, and a load 850. The receiver 800 further couples to the load 850 for providing received power thereto. Receiver 800 is illustrated as being external to device acting as the load 850 but may be integrated into load 850. The receive antenna 804 may be operably connected to the receive circuitry 802. The receive antenna 804 may be configured as the receive antenna 218 as described above in reference to FIG. 2. In some implementations, the receive antenna 804 may be tuned to resonate at a frequency similar to a resonant frequency of the transmit antenna 404, or within a specified range of frequencies, as described above. The receive antenna 804 may be similarly dimensioned with transmit antenna 404 or may be differently sized based upon the dimensions of the load 850. The receive antenna 804 may be configured to couple to the magnetic field generated by the transmit antenna 404, as described above, and provide an amount of received energy to the receive circuitry 802 to power or charge the load 850.

The receive circuitry 802 may be operably coupled to the receive antenna 804 and the load 850. The receive circuitry may be configured as the receive circuitry 210 as described above in reference to FIG. 2. The receive circuitry 802 may be configured to match an impedance of the receive antenna 804, which may provide efficient reception of wireless power. The receive circuitry 802 may be configured to generate power based on the energy received from the receive antenna 804. The receive circuitry 802 may be configured to provide the generated power to the load 850. In some implementations, the receiver 800 may be configured to transmit a signal to the PTU 700 indicating an amount of power received from the PTU 700.

The receive circuitry 802 may include a processor-signaling controller 816 configured to coordinate the processes of the receiver 800 described below.

The receive circuitry 802 provides an impedance match to the receive antenna 804. The receive circuitry 802 includes power conversion circuitry 806 for converting a received energy into charging power for use by the load 850. The power conversion circuitry 806 includes an AC-to-DC converter 808 coupled to, a DC-to-DC converter 810. The AC-to-DC converter 808 rectifies the AC energy signal received at the receive antenna 804 into a non-alternating power while the DC-to-DC converter 810 converts the rectified AC energy signal into an energy potential (e.g., voltage) that is compatible with the load 850. Various AC-to-DC converters are contemplated including partial and full rectifiers, regulators, bridges, doublers, as well as linear and switching converters.

The receive circuitry 802 may further include a matching circuit 232. The matching circuit 232 may comprise one or more resonant capacitors in either a shunt or a series configuration. In some implementations these resonant capacitors may tune the receive antenna to a specific frequency or to a specific frequency range (e.g., a resonant frequency).

The load 850 may be operably connected to the receive circuitry 802. The load 850 may be configured as the battery 236 as described above in reference to FIG. 2. In some implementations the load 850 may be external to the receive circuitry 802. In other implementations the load 850 may be integrated into the receive circuitry 802.

FIG. 9A is a flowchart that includes a method for controlling the PTU of FIG. 7 based on an impedance of a driver circuit of the PTU, in accordance with exemplary implementations of the invention. The method 900 may be performed by the PTU 700 using the flexible antenna 214. In some implementations, the controller 714 or a similar component of the PTU 700 may perform the method 900. The method 900 may also be performed by the transmitter 204 of FIG. 2. A person having ordinary skill in the art will appreciate that the method 900 may be implemented by other suitable devices and systems. Although the method 900 is described herein with reference to a particular order, in various aspects, blocks herein may be performed in a different order, or omitted, and additional blocks may be added.

The method 900 begins at operation block 902, where the PTU 700 transmits power in a stable state or is prepared transmit power to one or more receivers (e.g., PRUs 800). When transmitting power in the stable state using the flexible antenna 214, the PTU 700 may maintain power transmission and operation for an extended period of time without a risk of damage or danger to the PTU 700 or the user. In some implementations, while in the stable state, the flexible antenna 600 may have an acceptable shape, configuration, and/or position (e.g., the flexible antenna 600 may be substantially planar when against or directing power to the user's back). Accordingly, the stable state may correspond to the acceptable shape, position, and/or configuration of the flexible antenna 600.

Operation block 904 includes measuring, via the PTU 700 (e.g., the controller 715 or an impedance measuring circuit or similar circuit or component, not shown), an output impedance of the driver circuit 224 of the PTU 700. In some implementations, the measured impedance may be stored in a memory. At operation block 906, the controller 715 (or the impedance measuring circuit,-etc.)-may compare the measured output impedance to a first threshold value. The controller 715 (or the impedance measuring circuit, etc.) may compare the measured output impedance to the first threshold value to determine whether the measured output impedance exceeds the first threshold value. The first threshold value may be established by an input from the user. In some implementations, the first threshold value is established when the PTU 700 and/or the driver circuit 224 is manufactured and is stored in a memory of the PTU 700, e.g., the memory 720. For example, the first threshold may be based on a design of the PTU 700, the driver circuit 224, or the flexible antenna 600. In some implementations, the first threshold may correspond to an upper threshold value. The upper threshold value may comprise a value beyond which the measured impedance may indicate a risk of damage to the PTU 700 or harm to the user. In some implementations, the first and/or second threshold may be set after being measured by the PTU 700.

If the controller 715 determines that the measured impedance is not greater than the first threshold, then the PTU 700 proceeds to compare the measured impedance to a second threshold at operation block 908. The controller 715 (or the impedance measuring circuit, etc.) may compare the measured output impedance to the second threshold value to determine whether the measured output impedance is less than the second threshold value. The second threshold value may be established by the input from the user. In some implementations, the second threshold value is established when the PTU 700 and/or the driver circuit 224 is manufactured and is stored in the memory 720. For example, the second threshold may be based on the design of the PTU 700, the driver circuit 224, or the flexible antenna 214. In some implementations, the second threshold may correspond to a lower threshold value. The lower threshold value may comprise a value below which the measured impedance may indicate insufficient power can be being transferred to the PRU 800 to charge the load 850 of FIG. 8.

If the controller 715 determines that the measured voltage is not less than the second threshold, then the PTU 700 proceeds to operate in a normal operation mode or state at operation block 912. Accordingly, the voltage is measured regardless of whether the PTU 700 is operating in the stable state (in normal operation) or in the safe mode. Furthermore, once the PTU 700 exits the safe mode and/or continues normal operation, the PTU 700 begins the cycle of measuring the driver circuit 224 impedance and repeats the method 900.

On the other hand, if the PTU 700 determines that the measured voltage is either greater than the first threshold or less than the second threshold, the PTU 700 may enter a safe mode or state or have the driver circuit 224 enter a safe mode at operation block 910. In some implementations, the safe mode may comprise the PTU 700 operating at one or more of a reduced transmit current level, a reduced driver circuit input and/or output voltage, and/or at a beacon pulse level. The safe mode may utilize a manual reset, or may comprise a complete power shut down of the PTU 700, among other options. The safe mode may correspond to a mode in which the controller 715 limits the transmit current of the driver circuit 224. For example, the controller 715 may stop wireless power transmissions by the PTU 700. In some implementations, the controller 715 reduces the power transmission by the PTU 700 by placing a limit on the transmit current during a charging operation. The controller 715 may limit the transmit current based on a particular measured voltage from operation block 904. For example, the further the measured voltage is from either the first or second threshold, the more the circuit 715 may limit the transmit current.

In some implementations, the first and second thresholds may correspond to a range of impedances. In some implementations, the first and second thresholds may correspond to a range of transmit currents. For example, the first threshold may correspond to a low transmit current at or below which energy transfer is inefficient and the second threshold may correspond to a high transmit current at or above which energy transfer may be damaging or detrimental to one of the PTU 700 or the PRU 800. In some implementations, the first and second thresholds may correspond to particular shapes, positions, and/or orientations. For example, the first threshold may correspond to a voltage measured when the flexible antenna 214 is folded over itself or potentially presents a dangerous condition for the user, while the second threshold may correspond to a voltage measured when the flexible antenna 214 is in a shape where too little power is transferred. When the flexible antenna 600 distorts, any of the impedance, the transmit current, and the voltage of the flexible antenna 600 may increase or decrease as a result of the distortion.

In some implementations, the safe mode may include switching to an alternate flexible or non-flexible transmit antenna (not shown) and executing the same measurements of operation blocks 906 and 908. If the alternate transmit antenna has a measured impedance that is within the first and second threshold values, then the PTU 700 may shut down the flexible antenna 214 and continue transmission via the alternate transmit antenna. If the measured impedance with the alternate transmit antenna violates either of the first or second threshold levels, then the PTU 700 may enter the safe state with the alternate transmit antenna and/or check conditions with an additional flexible or non-flexible transmit antenna (not shown). Once in the safe state or shut down, the PTU 700 may continue to measure the impedance of the output of the driver circuit 224 at the operation block 910 to determine if the measured impedance falls within a range established by the first and second threshold values so the PTU 700 can being normal operation through operation blocks 906, 908, and 912. In some implementations, the range established corresponds to a safe operational range of the driver circuit 224, which may correspond to safe shapes, positions, and/or orientations of the flexible antenna 600. Accordingly, the first threshold value establishes the top value of the operational range of the driver circuit 224 while the second threshold value establishes the bottom value of the operational range of the driver circuit 224.

In some implementations, at operation block 812, when the measured impedance is less than or equal to the first threshold value and greater than or equal to the second threshold value, the PTU 700 exits the safe state (if the PTU 700 was previously in the safe state) and continues normal operation, for example, in the stable state.

FIG. 9B is a flowchart that includes a plurality of steps of a method 920 for controlling charging operations of the wireless power transmitter (PTU) 700 of FIG. 7, in accordance with exemplary implementations of the invention. In some implementations, the charging operations of the PTU 700 may be based on a measured impedance threshold of the driver circuit 224 of the PTU 700 coupled to the flexible antenna 214 of FIGS. 6A and 6B relative to how quickly the impedance changes within a time frame. The method 920 may be performed by the PTU 700 using the flexible antenna 214. In some implementations, the controller 714 or a similar component of the PTU 700 may perform the method 920. The method 920 may also be performed by the transmitter 204 of FIG. 2. A person having ordinary skill in the art will appreciate that the method 920 may be implemented by other suitable devices and systems. Although the method 920 is described herein with reference to a particular order, in various aspects, blocks herein may be performed in a different order, or omitted, and additional blocks may be added.

The method 920 begins at operation block 922, where the PTU 700 transmits power in a stable state or is prepared transmit power to one or more receivers (e.g., PRUs 800), as described above. Operation block 924 includes measuring, via the PTU 700 (e.g., the controller 715 or an impedance measuring circuit or similar circuit or component, not shown), an output impedance of the driver circuit 224 of the PTU 700. In some implementations, the measured impedance may be stored in a memory, e.g., the memory 720, as a baseline impedance value.

At operation block 926, the controller 715 (or the impedance measuring circuit, etc.) may measure a impedance of the driver circuit 224 and store the measured impedance value in the memory 720 or any other internal or external memory. At operation block 928, the controller 715 may compare the measured impedance to the stored baseline impedance to determine whether the impedance has changed since the baseline impedance was measured. If the controller 715 determines that the measured impedance has changed since the baseline impedance was stored, then the controller 715 computes an impedance delta or difference between the baseline impedance and the measured impedance at operation block 930. The computed delta is then compared at operation block 932, by the controller 714, to a threshold value. The threshold value may be established by an input from the user. In some implementations, the threshold value is established when the PTU 700 and/or the driver circuit 224 is manufactured and is stored in a memory of the PTU 700, e.g., the memory 720. For example, the impedance threshold may be based on a design of the PTU 700, the driver circuit 224, or the flexible antenna 214.

If the controller 714 determines that the impedance delta does exceed the threshold, the controller 714 replaces the baseline impedance with the measured impedance at operation block 934. In some implementations, the controller 714 may save the replaced baseline impedance in the memory 720. At operation block 936, the controller 714 may determine whether the baseline impedance has been changed more than a threshold number of times within a given period of time. If the controller 714 determines that the baseline impedance has changed more than the threshold number of time within the given time period, then the PTU 700 may enter a safe mode at operation block 938. Alternatively, if the controller 714 determines that the baseline impedance has not changed more than the threshold number of time within the given time period, then the PTU 700 may continue normal operation at operation block 940. In some implementations, the determine whether or not the baseline impedance has changed more than the threshold number of times within the given time period includes incrementing a counter each time the baseline is updated with a measured impedance within the given time period. This counter may be compared with a threshold counter value, and if the counter exceeds the threshold counter value, the controller 714 may determine that the baseline impedance has changed more than the threshold number of times. Alternatively, if the counter does not exceed the threshold counter value, the controller 714 may continue to track the impedance baseline and measured impedance changes. In some implementations, the controller 714 enters (from safe mode) or maintains normal operation (e.g., in a normal mode) if the counter is less than a reset threshold. In some implementations, an algorithm may be utilized to determine when an antenna is rapidly changing its shape, for example, while doing sit-ups. Such repeated distortions, (e.g., having a quantity that exceeds a quantity threshold) within a threshold time period may cause a transition into the safe mode. However, a quantity of distortions less than the quantity threshold may be ignored.

FIG. 9C is another flowchart that includes a plurality of steps of a method 950 for controlling charging operations of the wireless power transmitter (PTU) 700 of FIG. 7, in accordance with exemplary implementations of the invention. In some implementations, the charging operations of the PTU 700 may be based on a measured transmit current threshold of the driver circuit 224 of the PTU 700 or the flexible antenna 214 of FIGS. 6A and 6B relative to a baseline transmit current of the driver circuit 224 or the flexible antenna 214. The method 950 may be performed by the PTU 700 using the flexible antenna 214. In some implementations, the controller 714 or a similar component of the PTU 700 may perform the method 950. The method 950 may also be performed by the transmitter 204 of FIG. 2. A person having ordinary skill in the art will appreciate that the method 950 may be implemented by other suitable devices and systems. Although the method 950 is described herein with reference to a particular order, in various aspects, blocks herein may be performed in a different order, or omitted, and additional blocks may be added.

The method 950 begins at operation block 952, where the PTU 700 transmits power in a stable state or is prepared transmit power to one or more receivers (e.g., PRUs 800), as described above. Operation block 954 includes measuring, via the PTU 700 (e.g., the controller 715 or a voltage measuring circuit), a voltage of the driver circuit 714 of the PTU 700. At operation block 956, the controller 715 or the voltage measuring circuit may determine whether the driver circuit voltage is in a steady state. A steady state may comprise the voltage not changing for a predetermined period of time, where the time is set by the user, by design constraints of the PTU 700 or one of its components at manufacture, or based on previous operation. If the driver circuit voltage is determined to not be in the steady state, then the method 950 repeats operation block 954 and operation block 956 until the driver circuit voltage is in a steady state.

Once the driver circuit voltage is no longer in the steady state, the PTU 700 measures and stores a magnitude of a transmit current of the PTU 700 at operation block 958. In some implementations, the driver circuit 224 of the PTU 700 measures the magnitude of the transmit current at the driver circuit 224. In some implementations, the controller 715 or a separate transmit current sensor measures the magnitude of the transmit current of the PTU 700 at the flexible antenna 214. In some implementations, the magnitude of the transmit current is stored in a memory of the PTU 700, for example, the memory 720 of the PTU 700.

At operation block 960, the controller 714 determines whether the driver circuit voltage has changed as compared to the initial voltage measurement. If the driver circuit voltage has changed, then the method 950 repeats the steps of operation blocks 956-960. If the driver circuit voltage has not changed since the initial measurement, then the PTU 700 (e.g., the controller 714) determines, at operation block 962, whether the transmit current of the PTU 700 has changed since being initially measured at operation block 958. If the PTU 700 determines that the transmit current did not change, then the PTU 700 repeats operation block 960 of the method 950.

If the PTU determines that the transmit current did change, then at block 964, the PTU determines whether the change in the transmit current exceeds a transmit current threshold. In some implementations, the change in the transmit current (e.g., the delta in the transmit current) may exist between the initial current measurement and subsequent current measurements while the driver circuit voltage changed. For example, this may occur when the blocks 956-960 of the method 950 are repeated, as mentioned herein. The transmit current threshold value may be established by an input from the user. In some implementations, the transmit current threshold value is established when the PTU 700 and/or the driver circuit 224 is manufactured and is stored in a memory of the PTU 700, e.g., the memory 720. For example, the transmit current threshold may be based on a design of the PTU 700, the driver circuit 224, or the flexible antenna 214.

If the transmit current change does not exceed the transmit current threshold, then the blocks 960-964 of method 950 are repeated. If the transmit current change does exceed the transmit current threshold, then, at operation block 966, the PTU 700 enters a safe mode. Safe mode identified at block 966 may correspond to the safe mode described above.

When in the safe mode, at operation block 968 of the method 950, the PTU 700 determines if different transmit current thresholds exist. The transmit current threshold may be a fixed current. However, in some embodiments, the transmit current threshold may be based on a relative change (i.e., 50% higher than a normal current or 80% higher than an idle current, etc.) In some embodiments, the transmit current threshold relationship may be set during manufacture or via a calibration or similar set. Once the threshold is updated, or if a different transmit current threshold does not exist and the threshold does not need to be updated, then the PTU 700 remeasures the transmit current at operation block 970.

The PTU 700 then determines whether the most recently measured transmit current changed from the previously measured transmit current at operation block 972, and, if it did, determines whether the current change exceeds the transmit current threshold at operation block 974. If, at operation block 972, the PTU 700 determines that the most recently measured transmit current did not change from the previously measured transmit current, then the PTU 700 repeats blocks 970 and 972 until the change is determined. If, at operation block 974, the PTU 700 determines that the most recent transmit current change exceeds the transmit current threshold at operation block 974, the PTU 700 repeats blocks 970, 972, and 974 until the change does not exceed the threshold. If the PTU 700 determines that the most recent transmit current change does not exceed the transmit current threshold at operation block 974, the PTU 700 continues normal operation at block 976.

FIG. 9D is a flowchart that includes a plurality of steps of a method 980 for controlling the wireless power transmitter (PTU) 700 based on a measured impedance of the flexible antenna 214 of FIGS. 6A and 6B, in accordance with exemplary implementations of the invention. In some implementations, the charging operations of the PTU 700 may be based on a measured voltage across a distributed capacitor of the flexible antenna 214. As the flexible antenna 214 changes shape, parasitic capacitances in the flexible antenna 214 change, as does the measured voltage across the flexible antenna 214. The method 980 may be performed by the PTU 700 using the flexible antenna 214. In some implementations, the controller 714 or a similar component of the PTU 700 may perform the method 980. The method 980 may also be performed by the transmitter 204 of FIG. 2. A person having ordinary skill in the art will appreciate that the method 980 may be implemented by other suitable devices and systems. Although the method 980 is described herein with reference to a particular order, in various aspects, blocks herein may be performed in a different order, or omitted, and additional blocks may be added.

Here, the voltage measured is at a distributed capacitor on the PTU wearable antenna. As the user moves, the winding-winding capacitance will change and increase/decrease the circulating currents. This results in a variation of the voltage on the distributed capacitor.

The method 980 begins at operation block 982, where the PTU 700 transmits power in a stable state or is prepared transmit power to one or more receivers (e.g., PRUs 800), as described above. Operation block 984 includes measuring, via the PTU 700 (e.g., the controller 715 or an impedance measuring circuit or similar circuit or component, not shown), a voltage across the flexible antenna 214. In some implementations, the measured voltage may be stored in a memory (e.g., the memory 720). At operation block 986, the PTU 700 may compare the measured voltage to a first threshold value. The PTU 700 may compare the measured voltage to the first threshold value to determine whether the measured voltage exceeds the first threshold value. The first threshold value may be established by an input from the user. In some implementations, the first threshold value is established when the PTU 700 and/or a component of the PTU 700 is manufactured and is stored in the memory 720. For example, the first threshold may be based on a design of the PTU 700, the driver circuit 224, or the flexible antenna 214. In some implementations, the first threshold may correspond to an upper threshold value. The upper threshold value may comprise a value beyond which the measured voltage may indicate a risk of damage to the PTU 700 or harm to the user. In some implementations, the first and/or second threshold may be set after being measured by the PTU 700. In some implementations, the PTU 700 measures a complex impedance change and may adjust the transmit current based on the measured complex impedance change. In some implementations, the adjusted transmit current may produce unsafe voltages or too high a current for the PTU 700 to generate safely. Accordingly, in some embodiments, another set of safety thresholds (i.e. an absolute maximum voltage or an absolute maximum current) may exist that the PTU 700 will not exceed.

If the PTU 700 determines that the measured voltage is not greater than the first threshold, then the PTU 700 proceeds to compare the measured voltage to a second threshold at operation block 988. The PTU 700 may compare the measured voltage to the second threshold value to determine whether the measured voltage is less than the second threshold value. The second threshold value may be established by the input from the user. In some implementations, the second threshold value is established when the PTU 700 and/or the driver circuit 224 is manufactured and is stored in the memory of the PTU 700. For example, the second threshold may be based on the design of the PTU 700, the driver circuit 224, or the flexible antenna 214. In some implementations, the second threshold may correspond to a lower threshold value. The lower threshold value may comprise a value below which the measured impedance may indicate insufficient power is being transferred to the PRU 800 to charge the load 850 of FIG. 8.

If the controller 715 determines that the measured voltage is not less than the second threshold, then the PTU 700 proceeds to operate in a normal operation mode or state at operation block 912. Accordingly, the voltage is measured regardless of whether the PTU 700 is operating in the stable state (in normal operation) or in the safe mode. Furthermore, once the PTU 700 exits the safe mode and/or continues normal operation, the PTU 700 begins the cycle of measuring the driver circuit 224 impedance and repeats the method 980.

On the other hand, if the PTU 700 determines that the measured voltage is either greater than the first threshold or less than the second threshold, the PTU 700 may enter a safe mode or state or have the driver circuit 224 enter a safe mode at operation block 910. In some implementations, the safe mode may comprise the PTU 700 operating at one or more of a reduced transmit current level, a reduced driver circuit input and/or output voltage, and/or at a beacon pulse level. The safe mode may utilize a manual reset, or may comprise a complete power shut down of the PTU 700, among other options. The safe mode may correspond to a mode in which the controller 715 limits the transmit current of the driver circuit 224. For example, the controller 715 may stop wireless power transmissions by the PTU 700. In some implementations, the controller 715 reduces the power transmission by the PTU 700 by placing a limit on the transmit current during a charging operation. The controller 715 may limit the transmit current based on a particular measured voltage from operation block 904. For example, the further the measured voltage is from either the first or second threshold, the more the circuit 715 may limit the transmit current.

In some implementations, the first and second thresholds may correspond to particular shapes, positions, and/or orientations. For example, the first threshold may correspond to a voltage measured when the flexible antenna 214 is folded over itself or potentially presents a dangerous condition for the user, while the second threshold may correspond to a voltage measured when the flexible antenna 214 is in a shape where too little power is transferred.

In some implementations, the safe mode may include switching to an alternate flexible or non-flexible transmit antenna (not shown) and executing the same measurements of operation blocks 906 and 908. If the alternate transmit antenna has a measured impedance that is within the first and second threshold values, then the PTU 700 may shut down the flexible antenna 214 and continue transmission via the alternate transmit antenna. If the measured impedance with the alternate transmit antenna violates either of the first or second threshold levels, then the PTU 700 may enter the safe state with the alternate transmit antenna and/or check conditions with an additional flexible or non-flexible transmit antenna (not shown). Once in the safe state or shut down, the PTU 700 may continue to measure the impedance of the output of the driver circuit 224 at the operation block 910 to determine if the measured impedance falls within a range established by the first and second threshold values so the PTU 700 can being normal operation through operation blocks 906, 908, and 912. In some implementations, the range established corresponds to a safe operational range of the driver circuit 224, which may correspond to safe shapes, positions, and/or orientations of the flexible antenna 214. Accordingly, the first threshold value establishes the top value of the operational range of the driver circuit 224 while the second threshold value establishes the bottom value of the operational range of the driver circuit 224.

In some implementations, at operation block 992, when the measured voltage is less than or equal to the first threshold value and greater than or equal to the second threshold value, the PTU 700 exits the safe state (if the PTU 700 was previously in the safe state) and continues normal operation, for example, in the stable state.

FIG. 10 is a flowchart that includes a plurality of steps of a method 1000 for transmitting wireless power to an implant or worn device via a power transmitter, in accordance with exemplary implementations of the invention. Method 1000 may be performed by one or more of the components of the transmitter 206. For example, the method 1000 could be performed by the controller 715 or the measure circuit 730 illustrated in FIG. 7. A person having ordinary skill in the art will appreciate that the method 1000 may be implemented by other suitable devices and systems. Although the method 1000 is described herein with reference to a particular order, in various implementations, blocks herein may be performed in a different order, or omitted, and additional blocks may be added.

The method 1000 begins at block 1005, where at least one of the following variables is measured: an impedance of a power amplifier that drives an antenna circuit comprising one or more flexible antennas configured for wireless power transfer, an output voltage of the power amplifier, and a current from the power amplifier. Once at least one of the variables is measured, the method 1000 proceeds to block 1010.

At block 1010, the transmitter determines that at least one of the variables falls outside of a corresponding threshold range associated with an operating condition of at least one of the one or more flexible antennas. Falling outside of the corresponding threshold range may be indicative of a deformation of a physical shape of at least one of the one or more flexible antennas. Alternatively, or additionally, falling outside of the corresponding threshold range may be indicative of a misalignment of at least one of the one or more flexible antennas from a power receiver.

At block 1015, the transmitter commands the power amplifier to transition to a first power mode from a second power mode based on the determination that at least one of the measured impedance, the measured voltage, and the measured current falls outside of the corresponding threshold range. The antenna circuit may transmit power in the first power mode at a power level less than the power level in the second power mode.

An apparatus for wirelessly transmitting power may perform one or more of the functions of method 1000, in accordance with certain implementations described herein. The apparatus may comprise means for measuring at least one of the following variables: an impedance of a power amplifier that drives an antenna circuit comprising one or more flexible antennas configured for wireless power transfer, an output voltage of the power amplifier, and a current from the power amplifier. In certain implementations, the means for measuring a variable can be implemented by the controller 715 or the measure circuit 730 (FIG. 7). In some implementations, the means for measuring a variable can be configured to perform the functions of block 1005 (FIG. 10). The apparatus may further comprise means for determining that at least one of the variables falls outside of a corresponding threshold range, indicative of a deformation of a physical shape of at least one of the one or more flexible antennas, or indicative of a misalignment of at least one of the one or more flexible antennas from a power receiver, associated with an operating condition of at least one of the one or more flexible antennas. In certain implementations, the means for determining can be implemented by the controller 715. In certain implementations, the means for determining can be configured to perform the functions of block 1010 (FIG. 10). The apparatus may further comprise means for commanding the power amplifier to transition to a first power mode from a second power mode based on the determination that at least one of the measured impedance, the measured voltage, and the measured current falls outside of the corresponding threshold range, the antenna circuit transmitting power in the first power mode at a power level less than the power level in the second power mode. In certain implementations, the means for commanding can be implemented by the controller 715 or the driver 224. In certain implementations, the means for commanding can be configured to perform the functions of block 1015 (FIG. 10).

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and method steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the implementations.

The various illustrative blocks, modules, and circuits described in connection with the implementations disclosed herein may be implemented or performed with a general purpose hardware processor, a Digital Signal Processor (DSP), an Application Specified Integrated Circuit (ASIC), a Field Programmable Gate Array (FPGA) or other programmable logic device, discrete gate or transistor logic, discrete hardware components, or any combination thereof designed to perform the functions described herein. A general purpose hardware processor may be a microprocessor, but in the alternative, the hardware processor may be any conventional processor, controller, microcontroller, or state machine. A hardware processor may also be implemented as a combination of computing devices, e.g., a combination of a DSP and a microprocessor, a plurality of microprocessors, one or more microprocessors in conjunction with a DSP core, or any other such configuration.

The steps of a method and functions described in connection with the implementations disclosed herein may be embodied directly in hardware, in a software module executed by a hardware processor, or in a combination of the two. If implemented in software, the functions may be stored on or transmitted as one or more instructions or code on a tangible, non-transitory computer readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the hardware processor such that the hardware processor can read information from, and write information to, the storage medium. In the alternative, the storage medium may be integral to the hardware processor. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media. The hardware processor and the storage medium may reside in an ASIC.

For purposes of summarizing the disclosure, certain aspects, advantages and novel features have been described herein. It is to be understood that not necessarily all such advantages may be achieved in accordance with any particular implementation. Thus, the invention may be embodied or carried out in a manner that achieves or optimizes one advantage or group of advantages as taught herein without necessarily achieving other advantages as may be taught or suggested herein.

Various modifications of the above-described implementations will be readily apparent, and the generic principles defined herein may be applied to other implementations without departing from the spirit or scope of the application. Thus, the present application is not intended to be limited to the implementations shown herein but is to be accorded the widest scope consistent with the principles and novel features disclosed herein.

What is claimed is:

1. An apparatus for transmitting wireless power, the apparatus comprising:
a detection circuit electrically coupled to a power amplifier driving an antenna circuit comprising one or more flexible antennas configured for wireless power transfer, the detection circuit configured to measure at least one of the following variables: an impedance of the power amplifier, an output voltage of the power amplifier, and a current from the power amplifier; and
a processor configured to:
determine that at least one of the variables falls outside of a corresponding threshold range, indicative of a deformation of a physical shape of at least one of the one or more flexible antennas or indicative of a misalignment of at least one of the one or more flexible antennas from a power receiver, associated with an operating condition of at least one of the one or more flexible antennas, and
command the power amplifier to transition to a first power mode from a second power mode based on the determination that at least one of the measured impedance, the measured voltage, and the measured current falls outside of the corresponding threshold range, the antenna circuit in the first power mode transmitting power at a power level less than the power level in the second power mode.

2. The apparatus of claim 1, wherein at least one of the variables falling outside of the corresponding threshold range is indicative of the physical shape of at least one of the one or more of the flexible antennas exceeding a threshold amount of deformation.

3. The apparatus of claim 1, wherein at least one of the variables falling below the corresponding threshold range is indicative of at least one of the one or more flexible antennas exceeding a threshold amount of misalignment from a power receiver.

4. The apparatus of claim 1, wherein the one or more flexible antennas are configured to generate a wireless field for transmitting at least one of power and communications to an implanted device implanted within a user's body.

5. The apparatus of claim 1, wherein each of the one or more flexible antennas is characterized by at least one of a shape, a distance in relation to the user's body, and an orientation in relation to the user's body as the user's body moves and changes position and wherein at least one of the impedance of the power amplifier, the output voltage of the power amplifier, and the current from the power amplifier corresponds to at least one of a shape, distance in relation to the user's body, and orientation in relation to the user's body.

6. The apparatus of claim 1, wherein the processor is further configured to command the power amplifier to transition to the second mode from the first mode when the at least one of the measured impedance, the measured voltage, and the measured current falls within of the corresponding threshold range.

7. The apparatus of claim 1, wherein the processor is further configured to control the detection circuit to periodically measure the one or more of the impedance of the power amplifier, the output voltage of the power amplifier, and the current from the power amplifier.

8. The apparatus of claim 1, further comprising an electrode, wherein the detection circuit is further configured to measure second and third impedances between each of two terminals of the power amplifier and the electrode, respectively.

9. The apparatus of claim 8, wherein the electrode is a conductive pad in contact with an area of skin of a user.

10. The apparatus of claim 1, wherein the detection circuit is configured to:
measure the at least one of the impedance of the power amplifier, the output voltage of the power amplifier, and the current from the power amplifier when the antenna circuit initially generates a wireless charging field and wherein the processor is further configured to access at least one of current, impedance, and voltage load limits based on one or more of the measured impedance, the measured voltage, and the measured current.

11. The apparatus of claim 10, further comprising a variable capacitance component by which the processor is further configured to adjust a tuning point of the antenna circuit based on the at least one current, impedance, and voltage load limits.

12. The apparatus of claim 1, further comprising a user indicator configured to indicate to a user that at least one of the one or more flexible antennas is in a poor charging position based on at least one of the measured impedance, the measured voltage, and the measured current.

13. The apparatus of claim 1, wherein the antenna circuit is a first antenna circuit and further comprising a second antenna circuit, wherein the first antenna circuit and the second antenna circuit are selectively coupled to the power amplifier and wherein the processor is further configured to command the power amplifier to select the second antenna circuit to power or charge the power receiver based on the determination that at least one of the measured impedance, the measured voltage, and the measured current falls outside the corresponding threshold range.

14. The apparatus of claim 1, wherein the first power mode corresponds to a mode in which the antenna circuit transmits power at a rate approaching zero.

15. A method of transmitting wireless power, the method comprising:
measuring at least one of the following variables: an impedance of a power amplifier that drives an antenna circuit comprising one or more flexible antennas configured for wireless power transfer, an output voltage of the power amplifier, and a current from the power amplifier;
determining that at least one of the variables falls outside of a corresponding threshold range, indicative of a deformation of a physical shape of at least one of the one or more flexible antennas, or indicative of a misalignment of at least one of the one or more flexible antennas from a power receiver, associated with an operating condition of at least one of the one or more flexible antennas; and
commanding the power amplifier to transition to a first power mode from a second power mode based on the determination that at least one of the measured impedance, the measured voltage, and the measured current falls outside of the corresponding threshold range, the antenna circuit transmitting power in the first power mode at a power level less than the power level in the second power mode.

16. The method of claim 15, wherein at least one of the variables falling outside the corresponding threshold range is indicative of the physical shape of at least one of the one or more of the flexible antennas exceeding a threshold amount of deformation.

17. The method of claim 15, wherein at least one of the variables falling below the corresponding threshold range is indicative of at least one of the one or more flexible antennas exceeding a threshold amount of the misalignment from the power receiver.

18. The method of claim 15, further comprising generating a wireless field, via one or more of the one or more flexible antennas, for transmitting at least one of power and communications to an implanted device implanted within a user's body.

19. The method of claim 15, wherein the each of the one or more flexible antennas is characterized by at least one of a shape, a distance in relation to the user's body, and an orientation in relation to the user's body as the user's body moves and changes position and wherein the at least one impedance of the power amplifier, the output voltage of the power amplifier, and the current from the power amplifier corresponds to at least one of the shape, the distance in relation to the user's body, and the orientation in relation to the user's body.

20. The method of claim 15, further comprising commanding the power amplifier to transition to the second mode from the first mode when the at least one of the measured impedance, the measured voltage, and the measured current falls within of the corresponding threshold range.

21. The method of claim 15, wherein measuring the one or more of the impedance of the power amplifier, the output voltage of the power amplifier, and the current from the power amplifier comprises periodically measuring the one or more of the impedance of the power amplifier, the output voltage of the power amplifier, and the current from the power amplifer.

22. The method of claim 15, wherein measuring the one or more of the impedance of the power amplifier, the output voltage of the power amplifier, and the current from the power amplifier further comprises measuring second and third impedances between each of two terminals of the power amplifier and an electrode, respectively.

23. The method of claim 22, wherein the electrode is a conductive pad in contact with an area of skin of a user.

24. The method of claim 15, wherein measuring the at least one of the impedance of the power amplifier, the output voltage of the power amplifier, and the current from the power amplifier comprises measuring the at least one of the impedance of the power amplifier, the output voltage of the power amplifier, and the current from the power amplifier when the antenna circuit initially generates a wireless charging field, the method further comprising accessing at least one of current, impedance, and voltage load limits based on one or more of the measured impedance, the measured voltage, and the measured current.

25. The method of claim 24, further comprising adjusting a tuning point of the antenna circuit based on the at least one current, impedance, and voltage load limits.

26. The method of claim 15, further comprising indicating to a user that the at least one of the one or more flexible antennas is in a poor charging position based on at least one of the measured impedance, the measured voltage, and the measured current.

27. The method of claim 16, wherein the antenna circuit is a first antenna circuit and wherein the method further comprises selectively coupling one of the first antenna circuit and a second antenna circuit to the power amplifier and further comprises commanding the power amplifier to select the second antenna circuit to power or charge the power receiver based on the determination that at least one of the measured impedance, the measured voltage, and the measured current circuit falls outside the corresponding threshold range.

28. The method of claim 15, wherein the first power mode corresponds to a mode in which the antenna circuit transmits power at a rate approaching zero.

29. An apparatus for transmitting wireless power, the apparatus comprising:
means for measuring at least one of the following variables: an impedance of a power amplifier that drives an antenna circuit comprising one or more flexible antennas configured for wireless power transfer, an output voltage of the power amplifier, and a current from the power amplifier;
means for determining that at least one of the variables falls outside of a corresponding threshold range, indicative of a deformation of a physical shape of at least one of the one or more flexible antennas, or indicative of a misaligmnent of at least one of the one or more flexible antennas from a power receiver, associated with an operating condition of at least one of the one or more flexible antennas; and
means for commanding the power amplifier to transition to a first power mode from a second power mode based on the determination that at least one of the measured impedance, the measured voltage, and the measured current falls outside of the corresponding threshold range, the antenna circuit transmitting power in the first power mode at a power level less than the power level in the second power mode.

30. A non-transitory, computer-readable storage medium, comprising code executable to:
measure at least one of the following variables: an impedance of a power amplifier that drives an antenna circuit comprising one or more flexible antennas configured for wireless power transfer, an output voltage of the power amplifier, and a current from the power amplifier;
determine that at least one of the variables falls outside of a corresponding threshold range, indicative of a deformation of a physical shape of at least one of the one or more flexible antennas, or indicative of a misalignment of at least one of the one or more flexible antennas from a power receiver, associated with an operating condition of at least one of the one or more flexible antennas; and
command the power amplifier to transition to a first power mode from a second power mode based on the determination that at least one of the measured impedance, the measured voltage, and the measured current falls outside of the corresponding threshold range, the antenna circuit transmitting power in the first power mode at a power level less than the power level in the second power mode.
